(19) United States
(12) Patent Application Publication
(10) Pub. No.: US 2026/0046400 A1
(43) Pub. Date: Feb. 12, 2026

(54) METHOD AND APPARATUS FOR IMAGE ENCODING AND DECODING

(71) Applicant: HUAWEI TECHNOLOGIES CO., LTD., Shenzhen (CN)

(72) Inventors: Timofey Mikhailovich Solovyev, Munich (DE); Alexander Alexandrovich Karabutov, Munich (DE); Elena Alexandrovna Alshina, Munich (DE); Yibo Shi, Beijing (CN)

(73) Assignee: HUAWEI TECHNOLOGIES CO., LTD., Shenzhen (CN)

(21) Appl. No.: 19/361,610

(22) Filed: Oct. 17, 2025

Related U.S. Application Data
(63) Continuation of application No. PCT/CN2024/088770, filed on Apr. 19, 2024.

(30) Foreign Application Priority Data
Apr. 19, 2023 (WO) PCT/EP2023/060200
Aug. 11, 2023 (WO) PCT/CN2023/112712

(51) Int. Cl. H04N 19/115; H04N 19/184; H04N 19/196

(52) U.S. Cl. CPC H04N 19/115; H04N 19/184; H04N 19/196

(57) ABSTRACT

The present disclosure provides techniques for improving signaling efficiency in the context of rate control governing a desired ratio of bitrate load and quality in image compression. It is provided a method for encoding an image comprising obtaining the image, encoding the image into a bitstream based on a first coding parameter, wherein the first coding parameter is indicative of a first displacement between a first target rate control parameter and a first reference rate control parameter, and encoding the first coding parameter into the bitstream. Further, it is provided a method for decoding an image, comprising receiving a bitstream comprising coded data of the image, parsing the bitstream to obtain a first coding parameter, wherein the first coding parameter is indicative of a first displacement between a first target rate control parameter and a first reference rate control parameter, and reconstructing the image based on the first coding parameter.

### CROSS-REFERENCE TO RELATED APPLICATIONS

This application is a continuation of International Application No. PCT/CN2024/088770, filed on Apr. 19, 2024, which claims priority to Chinese Patent Application No. PCT/EP2023/060200, filed on Apr. 19, 2023 and International Application No. PCT/CN2023/112712, filed on Aug. 11, 2023. All of the aforementioned patent applications are hereby incorporated by reference in their entireties.

### TECHNICAL FIELD

Embodiments of the present disclosure generally relate to the field of encoding and decoding data based on a neural network architecture. In particular, some embodiments relate to methods and apparatuses for such encoding images and/or videos into a bitstream and decoding images and/or videos from a bitstream using a plurality of processing layers.

### BACKGROUND

Hybrid image and video codecs have been used for decades to compress image and video data. In such codecs, signal is typically encoded block-wisely by predicting a block and by further coding only the difference between the original bock and its prediction. In particular, such coding may include transformation, quantization and generating the bitstream, usually including some entropy coding. Typically, the three components of hybrid coding methods—transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approaches have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between an encoder and a decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

Particularly, herein improving signaling efficiency in the context of rate control governing a desired ratio of bitrate load and quality in image compression is addressed.

Some embodiments of this disclosure are set out in the appended set of claims. The foregoing and other objects are achieved by the subject matter of the independent claims. Further implementation forms are apparent from the dependent claims, the description and the figures.

According to a first aspect, it is provided a method for encoding an image, comprising obtaining the image, encoding the image into a bitstream based on a first coding parameter, wherein the first coding parameter is indicative of a first displacement between a first target rate control parameter and a first reference rate control parameter, and encoding the first coding parameter into the bitstream.

Here and in the following, the image can be, for example, a still image/picture or a frame of a video.

The first coding parameter may be directly encoded into the bitstream and signaled or another coding parameter obtained based on the first coding parameter may be encoded into the bitstream and signaled.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training. Here and in the following the rate control parameter is a parameter used to control the ratio between bitrate and distortion (see also detailed description below).

In particular, the first target rate control parameter may be the weighting coefficient between the bitrate and distortion used in a loss function during the training.

Contrary to the art, according to the method for encoding an image according to the first aspect and any implementation thereof the first displacement between a first target rate control parameter and a first reference rate control parameter is signaled (rather than signaling a rate control parameter selected by an encoder) which results in significant reduction of the number of bits to be signaled for rate control. According to an embodiment, the first coding parameter is signaled with N bits, wherein N is an integer less than or equal to 16. For example, N is equal to 12. Here and in the following it holds that when the first coding parameter is represented by a fixed-point value having N bits, K bits of the N bits represent a fractional part of the first coding parameter and (N−K) bits of the N bits represent an integer part of the first coding parameter, wherein Nis an integer and K is an integer less than or equal to N.

At a decoder side the number of operations necessary for obtaining a target gain vector (see detailed description below) is also significantly reduced as compared to the art.

According to an embodiment, the first coding parameter is represented by a fixed-point value. This allows that all calculations based on the signaled first coding parameter involved in the rate control can be restricted to fixed-point arithmetic calculations which can guarantee bit exact calculation behavior on different devices. Contrary to the art, no floating-point calculations, for example, for obtaining a gain vector are needed. In this context, it should be noted that in a fixed-point representation, numbers are represented and manipulated in integer format while in a floating-point representation, in addition to integer arithmetic, floating-point arithmetic is to be handled, i.e., numbers are represented by the combination of a mantissa (or a fractional part) and an exponent part such that the processor needs hardware for manipulating both of these parts. As a result, dealing with floating-point operations involve more logic elements and more cycles (more time) to manipulate floating-point values. Consequently, restriction to fixed-point arithmetic saves costs and computational time besides providing for arithmetic stability and independence of numerical results from the actual hardware used.

According to an embodiment, the first coding parameter, the first target rate control parameter and the first reference rate control parameter are for coding luma data (a luma component) of the image.

According to an embodiment, the first coding parameter, the first target rate control parameter and the first reference rate control parameter are for coding a primary component of the image, wherein the primary component may be a luma component.

In principle, rate control concerns both luma and chroma components. Thus, the method of the first aspect and any of the above-described implementations may also comprise signaling related to a chroma rate control parameter.

According to an embodiment, the method further comprises encoding a second coding parameter into the bitstream, wherein the second coding parameter is indicative of a second displacement between a second target rate control parameter and a second reference rate control parameter, and wherein the second coding parameter, the second target rate control parameter and the second reference rate control parameter are for coding chroma data (a chroma component) of the image.

The second displacement may be a difference or a ratio. The second target rate control parameter may be a rate control parameter selected by an encoder performing the method for encoding an image according to the first aspect and any implementation thereof and the second reference rate control parameter may be a rate control parameter used in model training. In particular it may be the weighting coefficient between the bitrate and distortion used in loss function during the training.

According to another implementation, the method further comprises encoding a second coding parameter into the bitstream, wherein the second coding parameter is indicative of a second displacement between a second target rate control parameter and a second reference rate control parameter, wherein the second coding parameter, the second target rate control parameter and the second reference rate control parameter are for coding a secondary component of the image, for example, a chroma component.

Again, the second displacement may be a difference or a ratio, the second target rate control parameter may be a rate control parameter selected by an encoder performing the method for encoding an image according to the first aspect and any implementation thereof and the second reference rate control parameter may be a rate control parameter used in model training. In particular it may be the weighting coefficient between the bitrate and distortion used in loss function during the training.

Rate control based on the second coding parameter provides similar advantages as the ones described above related to rate control based on the first coding parameter.

In principle, for luma rate control and chroma rate control the same or different rate control parameters may be used. Thus, according to an embodiment, the encoding of the second coding parameter is based on a flag indicating that different rate control parameters (e.g., target rate control parameter, reference rate control parameter and thus the displacement between the target rate control parameter and the reference rate control parameter) are used for coding the luma data and the chroma data of the image. In most of the applications the reference rate control parameters for the primary and secondary components (luma and chroma) are the same, whereas the target rate control parameters can be different and so the displacements are different too.

According to another implementation, the encoding of the second coding parameter is based on a flag indicating that different rate control parameters (e.g., target rate control parameter, reference rate control parameter and thus the displacement between the target rate control parameter and the reference rate control parameter) are used for coding the primary (for example, luma) and secondary (for example, chroma) components of the image.

According to an embodiment, similar to the first coding parameter the second coding parameter is represented by a fixed-point value.

The method according to the first aspect or any of the implementation thereof may also comprise encoding a third coding parameter into the bitstream. The third coding parameter may be indicative of an index of a trained model associated with at least one of the first reference rate control parameter and the second reference rate control parameter. Depending on actual applications, different trained models may be considered appropriate for accurate image reproduction and selection of the most appropriate model can be achieved based on the signaled third coding parameter. According to an embodiment, the third coding parameter may be used for deriving a target gain vector.

According to an embodiment, at least one of the first coding parameter and the second coding parameter is signaled using one or more of the following codes:
binary code;
unary code;
truncated unary code; and
exp-Golomb code.

According to an embodiment, the first coding parameter is in logarithmic scale (i.e., is a logarithmic expression). According to another implementation, at least one of the first coding parameter, the second coding parameter, the first target rate control parameter, the second target rate control parameter, the first reference rate control parameter and the second reference rate control parameter is in logarithmic scale. Calculations in the logarithmic domain may be particularly effectively performed. One of the reasons for this is that the linear domain multiplication corresponds to the addition in the logarithmic domain. So, more complex operations can be replaced by less complex ones, when the computations are performed in the logarithmic domain. In particular, instead of multiplication by the gain vector, an addition to the gain vector can be used in the logarithmic domain.

According to an embodiment, encoding the first coding parameter into the bitstream comprises obtaining an adjusted value of the first coding parameter and encoding the adjusted value of the first coding parameter into the bitstream. The adjusted value can be a value of the above cited other coding parameters that according to an alternative can be obtained based on the first coding parameter, directly encoded into the bitstream and signaled. For example, the adjusted value of the first coding parameter is obtained by adding 2^{N-1} to a value of the first coding parameter, wherein N is the number of bits used to signal the first coding parameter.

According to an embodiment, the encoding the image into a bitstream based on a first coding parameter comprises obtaining a target gain vector based on the first coding parameter and encoding the image based on the target gain vector.

According to an embodiment, the target gain vector is defined as follows:

$${m}_{log} = {m}_{log}^{t} + betaDisplacementLog$$

wherein m_{log} denotes the target gain vector, m^{t}_{log} denotes a reference forward gain vector for a model with index t, t is indicative of an index of a trained model associated with at least one of the first reference rate control parameter and the second reference rate control parameter, and betaDisplacementLog is associated with the first coding parameter. In particular, betaDisplacementLog may denote the first coding parameter or the above cited other coding parameter obtained based on the first coding parameter.

Implementations of the method for encoding an image can be combined where considered appropriate.

Complementary to the method for encoding an image according to the first aspect and any implementation thereof and providing similar advantages it is provided a method for decoding an image.

According to a second aspect, it is provided a method for decoding an image, comprising receiving a bitstream comprising coded data of the image, parsing the bitstream to obtain a first coding parameter, wherein the first coding parameter is indicative of a first displacement between a first target rate control parameter and a first reference rate control parameter and reconstructing the image based on the first coding parameter.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training. In particular, the first target rate control parameter may be the weighting coefficient between the bitrate and distortion used in a loss function during the training.

According to an option, parsing the bitstream to obtain a first coding parameter comprises parsing another coding parameter (syntax element) from the bitstream and obtaining the first coding parameter based on the other coding parameter. This option is denoted as option A in the following.

According to another option, parsing the bitstream to obtain a first coding parameter comprises directly parsing the first coding parameter from the bitstream. This option is denoted as option B in the following.

According to option B reconstructing the image based on the first coding parameter may comprise obtaining another coding parameter based on the parsed first coding parameter and reconstructing the image based on the other coding parameter.

The first coding parameter may be represented by a fixed-point value. The first coding parameter may be signaled with N bits, wherein N is an integer less than or equal to 16. For example, N is equal to 12.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training.

According to an embodiment, the first coding parameter, the first target rate control parameter and the first reference rate control parameter are for coding luma data (a luma component) of the image.

According to an embodiment, the first coding parameter, the first target rate control parameter and the first reference rate control parameter are for coding a primary component of the image, for example, a luma component.

According to an embodiment, the method for decoding an image further comprises parsing the bitstream to obtain a second coding parameter, wherein the second coding parameter is indicative of a second displacement between a second target rate control parameter and a second reference rate control parameter, and wherein the second coding parameter, the second target rate control parameter and the second reference rate control parameter are for coding chroma data (a chroma component) of the image.

The second displacement may be a difference or a ratio. The second target rate control parameter may be a rate control parameter selected by an encoder performing the method according to the first aspect and any implementation thereof and the second reference rate control parameter may be a rate control parameter used in model training. In particular, the second target rate control parameter may be the weighting coefficient between the bitrate and distortion used in a loss function during the training.

According to an embodiment, the method for decoding an image further comprises parsing the bitstream to obtain a second coding parameter, wherein the second coding parameter is indicative of a second displacement between a second target rate control parameter and a second reference rate control parameter, and wherein the second coding parameter, the second target rate control parameter and the second reference rate control parameter are for coding a secondary component of the image, for example, a chroma component.

Again, the second displacement may be a difference or a ratio, the second target rate control parameter may be a rate control parameter selected by an encoder performing the method according to the first aspect and any implementation thereof and the second reference rate control parameter may be a rate control parameter used in model training.

According to an embodiment, the obtaining of the second coding parameter is based on a flag indicating that different rate control parameters (e.g., target rate control parameter, reference rate control parameter and thus the displacement between the target rate control parameter and the reference rate control parameter) are used for coding the luma data and the chroma data of the image.

According to an embodiment, the obtaining of the of second coding parameter is based on a flag indicating that different rate control parameters (e.g., target rate control parameter, reference rate control parameter and thus the displacement between the target rate control parameter and the reference rate control parameter) are used for coding the primary and secondary components of the image.

Similar to the first coding parameter, the second coding parameter may be represented by a fixed-point value.

According to an embodiment, the method for decoding an image further comprises parsing the bitstream to obtain a third coding parameter. The third coding parameter may be indicative of an index of a trained model associated with at least one of the first reference rate control parameter and the second reference rate control parameter. According to an embodiment, the third coding parameter may be used for deriving a target gain vector.

According to an embodiment, at least one of the first coding parameter and the second coding parameter is signaled using one or more of the following codes:
binary code;
unary code;
truncated unary code; and
exp-Golomb code.

According to an embodiment, the first coding parameter is in logarithmic scale. According to another implementation, at least one of the first coding parameter, the second coding parameter, the first target rate control parameter, the second target rate control parameter, the first reference rate control parameter and the second reference rate control parameter is in logarithmic scale.

According to an embodiment, the reconstructing the image based on the first coding parameter comprises obtaining an intermediate parameter by subtracting 2^{N-1} from the first coding parameter, wherein N is the number of bits used to signal the first coding parameter and reconstructing the image based on the intermediate parameter. This implementation represents an example of option B defined above wherein the intermediate parameter is equal to the other coding parameter.

According to an embodiment, the reconstructing the image based on the first coding parameter comprises obtaining a target gain vector based on the first coding parameter and reconstructing the image based on the target gain vector. According to an embodiment, the target gain vector is defined as follows:

$${m}_{log} = {m}_{log}^{t} + betaDisplacementLog$$

wherein m_{log} denotes the target gain vector, m^{t}_{log} denotes a reference forward gain vector for a model with index t, t is indicative of an index of a trained model associated with at least one of the first reference rate control parameter and the second reference rate control parameter and betaDisplacementLog is associated with the first coding parameter. According to the above-defined option A, betaDisplacementLog may denote the first coding parameter. According to the above-defined option B, betaDisplacementLog may denote the other coding parameter.

Implementations of the method for encoding an image can be combined where considered appropriate.

The method for encoding an image according to the first aspect can be implemented in an encoding device and the method for decoding an image according to the second aspect can be implemented in a decoding device.

Furthermore, the following devices, computer program products, storage media and bitstreams are provided that provide similar advantages as described above.

According to a third aspect, it is provided an encoding device for encoding an image, comprising a memory containing instructions and a processor coupled to the memory, wherein the processor is configured to implement the instructions to cause the encoding device to perform the encoding method according to the first aspect or any implementation thereof.

According to a fourth aspect, it is provided a decoding device for decoding an image, comprising a memory containing instructions and a processor coupled to the memory, wherein the processor is configured to implement the instructions to cause the decoding device to perform the decoding method according to the second aspect or any implementation thereof.

According to a fifth aspect, it is provided a coding apparatus for coding an image comprising receiver units configured to receive an image to encode or to receive a bitstream to decode, transmitter units coupled to the receiver units, the transmitter units configured to transmit the bitstream to a decoder or to transmit a decoded image to a display, a memory coupled to at least one of the receiver units or the transmitter units, the memory configured to store instructions and a processor coupled to the memory, wherein the processor configured to execute the instructions stored in the memory to perform the method according to the first or second aspects or any implementation thereof.

According to a sixth aspect, it is provided an encoding device for encoding an image comprising an obtaining unit configured to obtain the image, an encoding unit configured to encode the image into a bitstream based on a first coding parameter, wherein the first coding parameter is indicative of a first displacement between a first target rate control parameter and a first reference rate control parameter, wherein the encoding unit is further configured to encode the first coding parameter into the bitstream. The encoding device according to the sixth aspect may be configured to directly encode the first coding parameter into the bitstream or another coding parameter obtained based on the first coding parameter. The encoding device according to the sixth aspect may be configured to perform the method according to the first aspect or any implementation thereof.

According to a seventh aspect, it is provided a decoding device for decoding an image comprising a receiving unit configured to receive a bitstream comprising coded data of the image, a parsing unit configured to parse the bitstream to obtain a first coding parameter, wherein the first coding parameter is indicative of a first displacement between a first target rate control parameter and a first reference rate control parameter, and a reconstructing unit configured to reconstruct the image based on the first coding parameter.

According to an option, parsing the bitstream to obtain a first coding parameter by the parsing unit comprises parsing another coding parameter (syntax element) from the bitstream and obtaining the first coding parameter based on the other coding parameter (cf. option A defined above). According to another option, parsing the bitstream to obtain a first coding parameter by the parsing unit comprises directly parsing the first coding parameter from the bitstream (cf. option B defined above). In this case, the reconstructing unit may be configured to reconstruct the image based on the first coding parameter by obtaining another coding parameter based on the parsed first coding parameter and reconstructing the image based on the other coding parameter.

The decoding device according to the seventh aspect may be configured to perform the method according to the second aspect or any implementation thereof.

According to an eighth aspect, it is provided a coding system for coding an image comprising an encoder and
a decoder in communication with the encoder, wherein the encoder or the decoder includes the decoding device according to the fourth or seventh aspects, the encoding device according to the third or sixth aspects, or the coding apparatus to the fifth aspect.

According to a ninth aspect, it is provided a computer program product comprising program code for performing the method according to the first or second aspects or any implementation thereof when executed on one or more processors.

According to a tenth aspect, it is provided a computer-readable storage medium, wherein the computer-readable storage medium stores a computer program that can be executed by one or more processors, and when the computer program is executed by the one or more processors, the one or more processors performs the method according to the first or second aspects or any implementation thereof.

According to an eleventh aspect, it is provided a coder comprising processing circuitry for carrying out the method according to the first or second aspects or any implementation thereof.

According to a twelfth aspect, it is provided a storage medium, wherein the storage medium stores a bitstream obtained by using the method according to the first aspect or any implementation thereof.

According to a thirteenth aspect, it is provided a bitstream comprising coded data of an image and a first coding parameter, wherein the first coding parameter is indicative of a first displacement between a first target rate control parameter and a first reference rate control parameter. The bitstream may comprise the first coding parameter directly or may comprise another coding parameter obtained based on the first coding parameter.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training.

The first coding parameter may be represented by a fixed-point value.

According to an embodiment, the first coding parameter is signaled with N bits, wherein N is an integer less than or equal to 16, for example, N is equal to 12.

According to an embodiment, the first coding parameter, the first target rate control parameter and the first reference rate control parameter are for coding luma data of the image.

According to an embodiment, the first coding parameter, the first target rate control parameter and the first reference rate control parameter are for coding a primary component of the image, for example, a luma component.

According to an embodiment, the bitstream further comprises a second coding parameter, wherein the second coding parameter is indicative of a second displacement between a second target rate control parameter and a second reference rate control parameter, wherein the second coding parameter, the second target rate control parameter and the second reference rate control parameter are for coding chroma data of the image.

The second displacement may be a difference or a ratio. The second target rate control parameter may be a rate control parameter selected by an encoder performing the method for encoding an image according to the first aspect and any implementation thereof and the second reference rate control parameter may be a rate control parameter used in model training.

According to an embodiment, the bitstream further comprises a second coding parameter, wherein the second coding parameter is indicative of a second displacement between a second target rate control parameter and a second reference rate control parameter, wherein the second coding parameter, the second target rate control parameter and the second reference rate control parameter are for coding a secondary component of the image, for example, a chroma component.

Again, the second displacement may be a difference or a ratio, the second target rate control parameter may be a rate control parameter selected by an encoder performing the method for encoding an image according to the first aspect and any implementation thereof and the second reference rate control parameter may be a rate control parameter used in model training.

According to an embodiment, the bitstream further comprises a flag indicating whether to use different rate control parameters (e.g., target rate control parameter, reference rate control parameter and thus the displacement between the target rate control parameter and the reference rate control parameter) for coding the luma data and the chroma data of the image.

According to an embodiment, the bitstream further comprises a flag indicating whether to use different rate control parameters (e.g., target rate control parameter, reference rate control parameter and thus the displacement between the target rate control parameter and the reference rate control parameter) for coding the primary and secondary components of the image.

According to an embodiment, the second coding parameter is represented by a fixed-point value.

According to an embodiment, the bitstream further comprises a third coding parameter, wherein the third coding parameter is indicative of an index of a trained model associated with at least one of the first reference rate control parameter and the second reference rate control parameter.

The individual implementations of the bitstream according to the thirteenth aspect can be combined with each other where appropriate.

According to a fourteenth aspect, it is provided a system for delivering a bitstream, comprising at least one storage medium, configured to store at least one bitstream according to the thirteenth aspect or any implementation thereof or the bitstream generated by the method according the first aspect or any implementation thereof, and a video streaming device, configured to obtain a bitstream from one of the at least one storage medium and send the bitstream to a terminal device, wherein the video streaming device comprises a content server or a content delivery server.

According to an embodiment, the system further comprises: a) one or more processors configured to perform encryption processing on the at least one bitstream to obtain at least one encrypted bitstream; and wherein the at least one storage medium is configured to store the encrypted bitstream, or b) one or more processors configured to convert a bitstream of the at least one encrypted bitstream in a first format into a bitstream in a second format, wherein the at least one storage medium is configured to store the bitstream in the second format.

According to an embodiment, the system further comprises:
a receiver, configured to receive a first operation request; and
a transmitter, configured to send the target bitstream to a terminal-side apparatus; and wherein
the one or more processors are configured to determine a target bitstream in the at least one storage medium in response to the first operation request.

According to an embodiment, the one or more processors are further configured to encapsulate a bitstream to obtain a transport stream in a third format and the transmitter, is further configured to send the transport stream in the third format to the terminal-side apparatus for display or send the transport stream in the third format to storage space for storage.

The implementations of the system according to the fourteenth aspect can be combined with each other where considered appropriate.

### BRIEF DESCRIPTION OF THE DRAWINGS

In the following embodiments of the present disclosure are described in more detail with reference to the attached figures and drawings, in which

FIG. 1 is a schematic drawing illustrating channels processed by layers of a neural network according to some embodiments;

FIG. 2 is a schematic drawing illustrating an autoencoder type of a neural network according to some embodiments;

FIG. 3A is a schematic drawing illustrating an exemplary network architecture for encoder and decoder side including a hyperprior model according to some embodiments;

FIG. 3B is a schematic drawing illustrating a general network architecture for encoder side including a hyperprior model according to some embodiments;

FIG. 3C is a schematic drawing illustrating a general network architecture for decoder side including a hyperprior model according to some embodiments;

FIG. 4 is a schematic drawing illustrating an exemplary network architecture for encoder and decoder side including a hyperprior model according to some embodiments;

FIG. 5 is a block diagram illustrating a structure of a cloud-based solution for machine based tasks such as machine vision tasks according to some embodiments;

FIG. 6A is a block diagram illustrating end-to-end video compression framework based on a neural networks according to some embodiments;

FIG. 6B is a block diagram illustrating some exemplary details of application of a neural network for motion field compression according to some embodiments;

FIG. 6C is a block diagram illustrating some exemplary details of application of a neural network for motion compensation according to some embodiments;

FIG. 7 is a schematic drawing illustrating a general scheme of the entropy coder according to some embodiments;

FIG. 8 is a schematic drawing illustrating a general scheme of usage entropy coding in autoencoder-based coders according to some embodiments;

FIG. 9 is a schematic drawing illustrating a general scheme of autoencoder-based coder with entropy coder and gain unit according to some embodiments;

FIG. 10 shows signalled values and decoder operations of conventional methods according to some embodiments;

FIG. 11 shows signalled values and decoder operations as proposed in the present application according to some embodiments;

FIG. 12 is a schematic drawing illustrating the relation of the first coding parameter and the gain vectors according to some embodiments;

FIG. 13 is a flow chart of an exemplary method for encoding an image as proposed according to some embodiments;

FIG. 14 is a flow chart of an exemplary method for decoding an image as proposed according to some embodiments;

FIG. 15 is a block diagram showing an example of a video encoding device configured to implement encoding embodiments of the present disclosure;

FIG. 16 is a block diagram showing an example of a video decoding device configured to implement decoding embodiments of the present disclosure;

FIG. 17 shows a bitstream structure;

FIG. 18 shows the encoding and decoding process using a gain vector scheme according to some embodiments;

FIG. 19 is a schematic drawing illustrating a multi-core encoder encoding channels of input data into substreams and concatenating the substreams into a bitstream according to some embodiments;

FIG. 20 is a schematic drawing illustrating an example encoder that is configured to implement embodiments of the present application;

FIG. 21 is a schematic drawing illustrating an example of a decoder that is configured to implement embodiments of this present application;

FIG. 22 is a block diagram showing an example of a video coding system configured to implement embodiments of the present disclosure;

FIG. 23 is a block diagram showing another example of a video coding system configured to implement embodiments of the present disclosure;

FIG. 24 is a block diagram showing another example of a video coding system configured to implement embodiments of the present disclosure;

FIG. 25 is a block diagram illustrating an example of an encoding apparatus or a decoding apparatus according to some embodiments;

FIG. 26 is a schematic drawing illustrating an example structure of a content supply system 3100 which realizes a content delivery service according to some embodiments;

FIG. 27 is a schematic drawing illustrating an example structure of a terminal service according to some embodiments;

FIG. 28 is a block diagram illustrating another example of an encoding apparatus or a decoding apparatus according to some embodiments;

FIG. 29 is a block diagram illustrating another example of an encoding apparatus or a decoding apparatus according to some embodiments;

FIG. 30 is a block diagram illustrating a computer vision task-classification-according to some embodiments;

FIG. 31 is a block diagram illustrating a computer vision task-super resolution-according to some embodiments;

FIG. 32 is a block diagram illustrating a computer vision task-denoising-according to some embodiments;

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps or operations are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

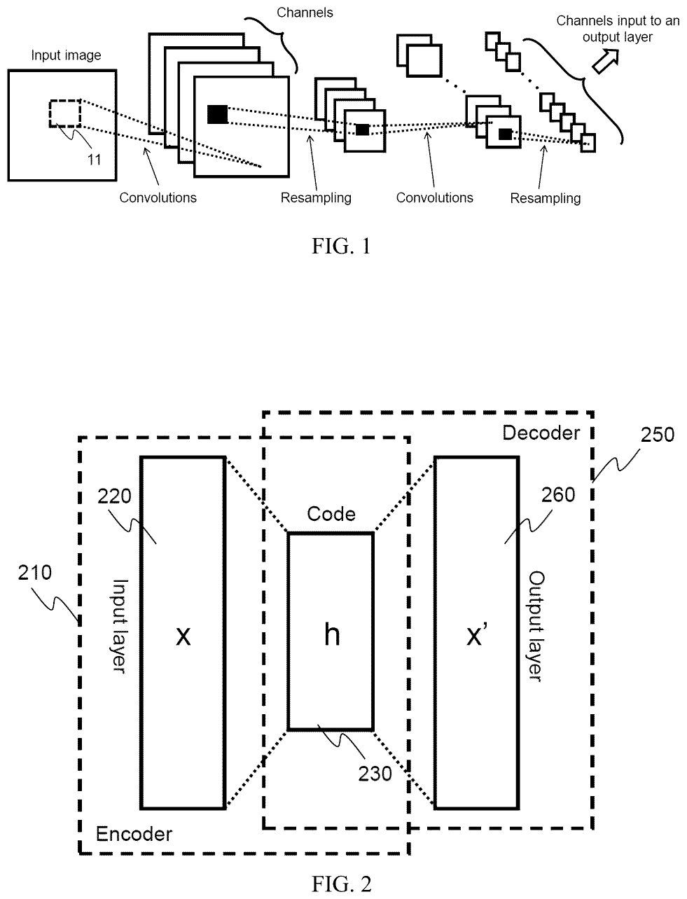

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favour compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

$$\begin{matrix}LeakyReLU ( x ) = max ( 0 , x ) + negative\_slope * min ( 0 , x ) , or \\ LeakyReLU ( x ) = \{ \begin{matrix}x , & if x \geq 0 \\ negative\_slope * x , & otherwise\end{matrix}\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)=N (0, l). Commonly, the shape of the variational and the likelihood distributions are chosen such that they are factorized Gaussians:

$$\begin{matrix}{q}_{ϕ} ( h \vert x ) = 𝒩 ( ρ ( x ) , {ω}^{2} ( x ) I ) \\ {p}_{ϕ} ( x \vert h ) = 𝒩 ( μ ( h ) , {σ}^{2} ( h ) I )\end{matrix}$$

where ρ(x) and ω² (x) are the encoder output, while μ(h) and σ² (h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

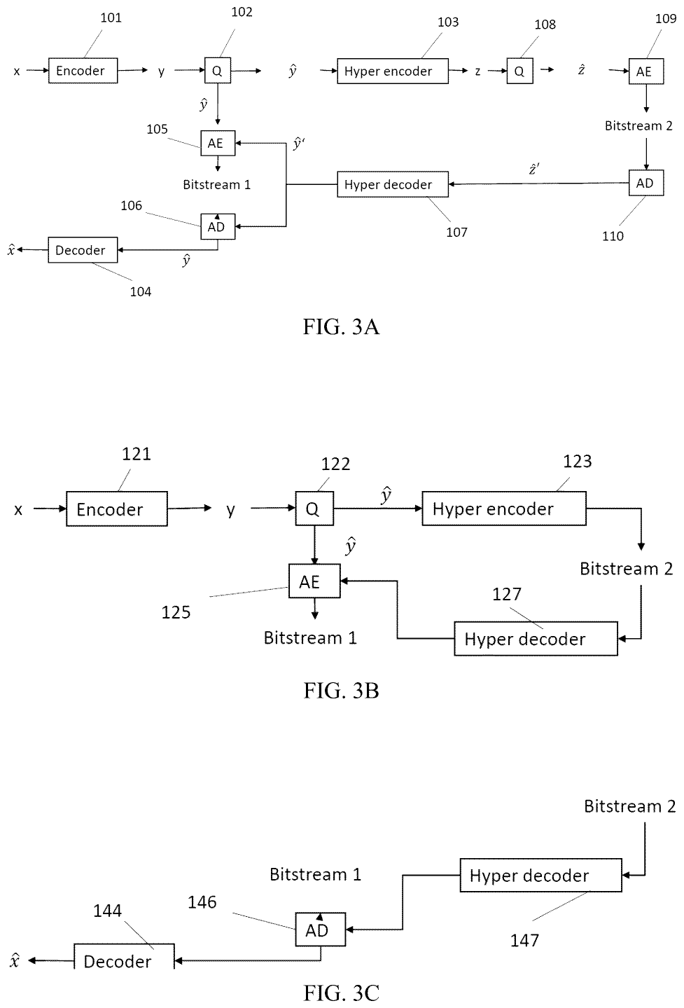

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ) The signal ŷ is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

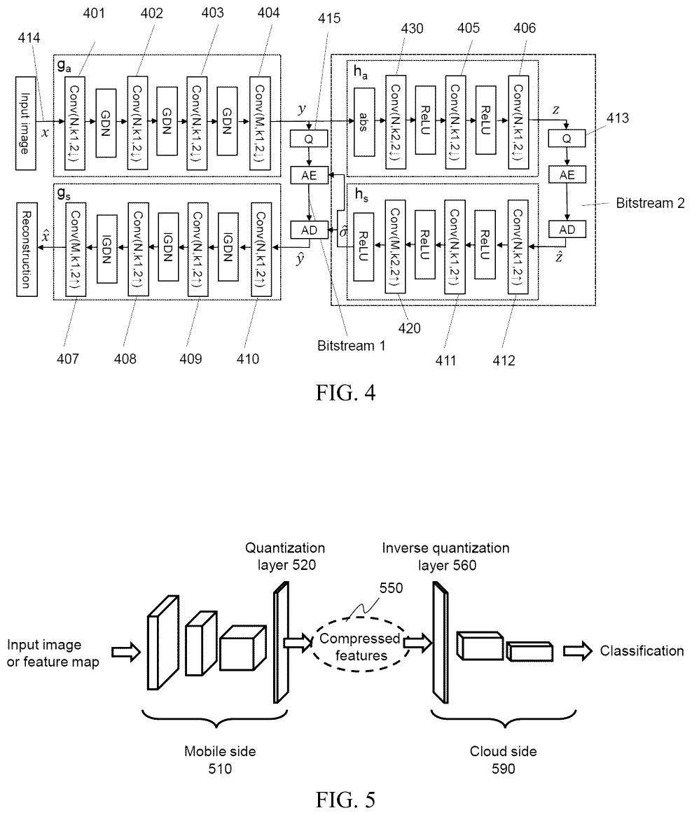

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓means that a downsampling with a factor of 2 is performed in this layer. Downsampling by a factor of 2 results in one of the dimensions of the input signal being reduced by half at the output. In FIG. 4, the 2↓indicates that both width and height of the input image is reduced by a factor of 2. Since there are 6 downsampling layers, if the width and height of the input image 414 (also denoted with x) is given by w and h, the output signal \hat{z} 413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao;” DVC: An End-to-end Deep Video Compression Framework”. Proceedings of the IEEE CVF Conference on Computer Vision and Pattern Recognition (CVPR), 2019, pp. 11006-11015, authors proposed the end-to-end deep video compression (DVC) model that jointly learns motion estimation, motion compression, and residual coding.

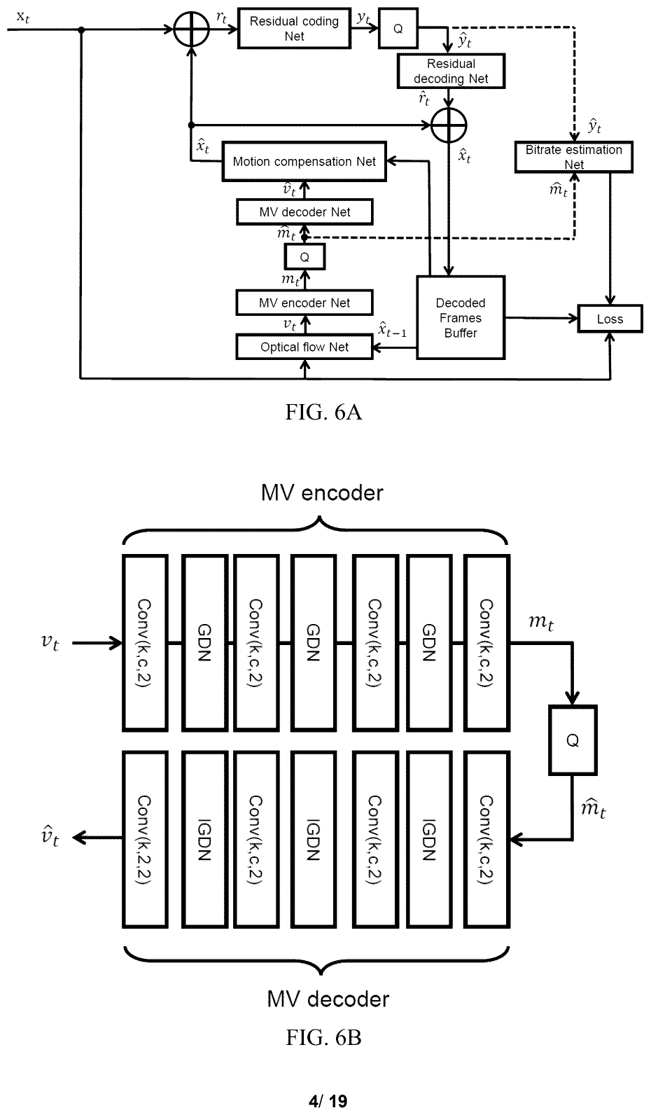

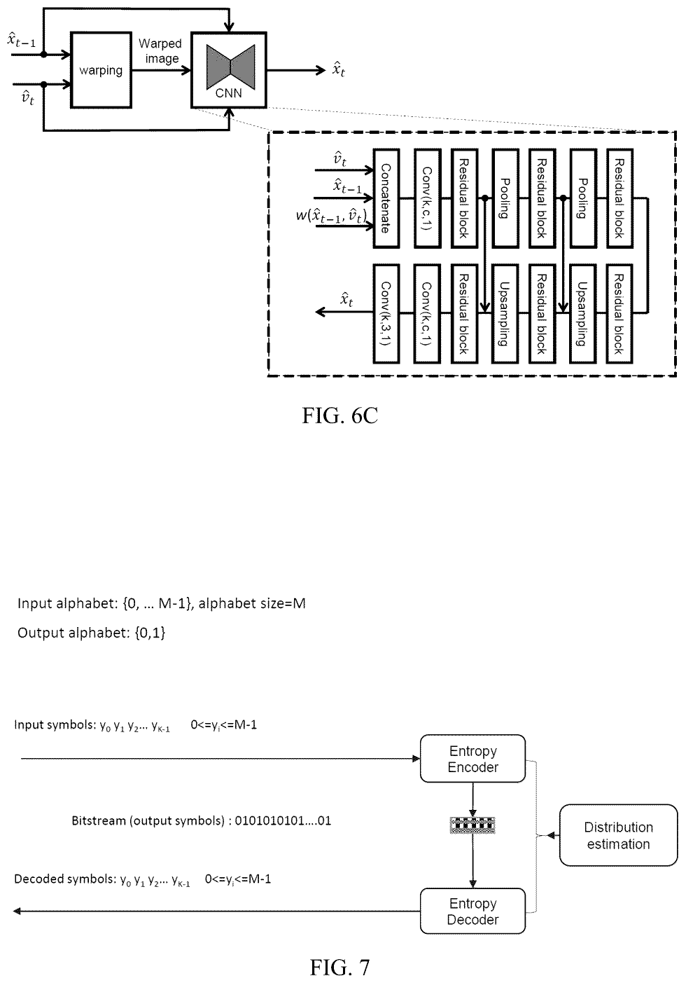

Such encoder is illustrated in FIG. 6A. In particular, FIG. 6A shows an overall structure of end-to-end trainable video compression framework. In order to compress motion information, a CNN was designated to transform the optical flow vₜ to the corresponding representations mₜ suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

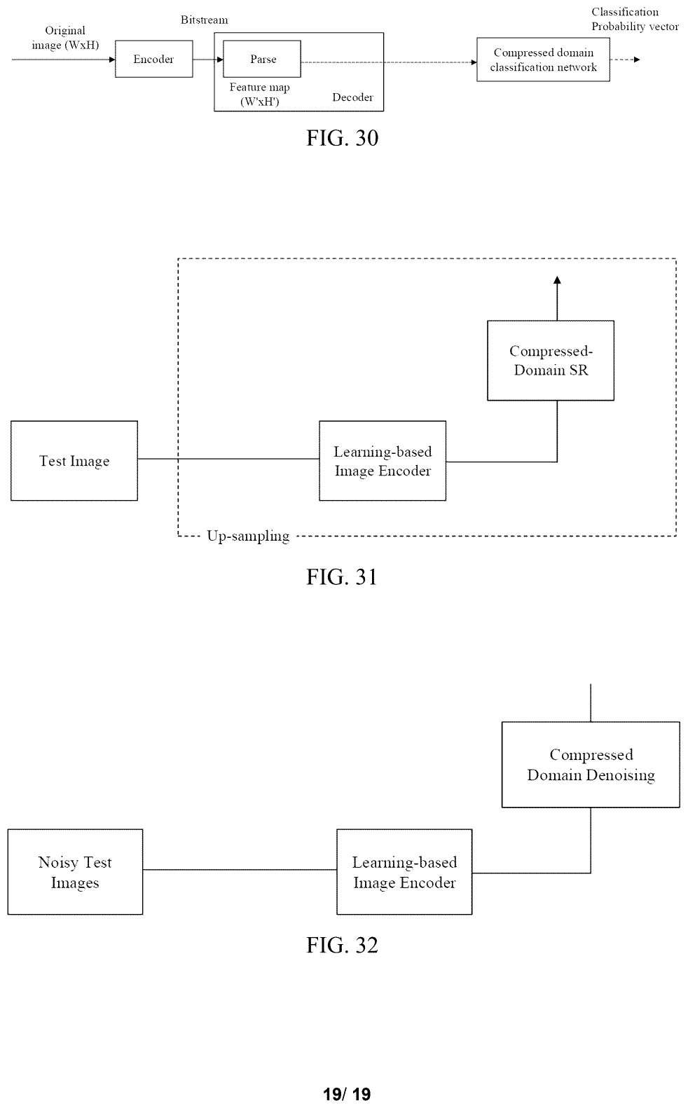

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In particular, FIG. 30 shows an example of a classification task, FIG. 31 shows an example of a super resolution task, and FIG. 32 shows an example of a denoising task. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the art autoencoder based approach to compression are also valid for machine vision tasks.

### Network Training

### Loss Function

The loss function may include a plurality of items. For an image encoding task, loss items related to reconstruction quality generally include a L1 loss, a L2 loss (or referred to as an MSE loss), an MS-SSIM loss, a VGG loss, an LPIPS loss, a GAN loss, and the like, and further include loss items related to bitstream size.

The L1 loss calculates an average value of errors between points to obtain a L1 loss value. The L1 loss function can better evaluate reconstruction quality of a structured region in an image.

Mean squared error (mean squared error, MSE) loss: a function for measuring a distance between two pieces of data. In this embodiment of this application, the MSE loss is also referred to as the L2 loss function. An average value of squares of errors between points is calculated to obtain an L2 loss value. The MSE loss may also be used to calculate a PSNR. The L2 loss is also a pixel-level loss. The L2 loss function can also better evaluate reconstruction quality of a structured region in an image. If the L2 loss function is used to optimize an image encoding and decoding network, an optimized image encoding and decoding network can achieve a higher PSNR.

Structural similarity index measure (structural similarity index measure, SSIM): an objective criterion for evaluating image quality. Higher SSIM indicates better image quality. In this embodiment of this application, structural similarity between two images at a scale is calculated to obtain an SSIM loss value. The SSIM loss is a loss based on an artificial feature. Compared with the L1 loss function and the L2 loss function, the SSIM loss function can more objectively evaluate image reconstruction quality, that is, evaluate a structured region and an unstructured region of an image in a more balanced manner. If the SSIM loss function is used to optimize an image encoding and decoding network, an optimized image encoding and decoding network can achieve a higher SSIM.

Multi-scale structural similarity index measure (multi-scale SSIM, MS-SSIM): an objective criterion for evaluating image quality. Higher SSIM indicates better image quality. Multi-layer low-pass filtering and downsampling are separately performed on two images to obtain image pairs at a plurality of scales. A contrast map and structure information are extracted from an image pair at each scale, and SSIM loss values at the corresponding scale are obtained based on the contrast map and the structure information. Luminance information of an image pair at a smallest scale is extracted, and a luminance loss value at the smallest scale is obtained based on the luminance information. Then, the SSIM loss values and the luminance loss value at the plurality of scales are aggregated in a manner to obtain an MS-SSIM loss value, for example, an aggregation manner in Equation (1):

$$MS - SSIM ( x , y ) = {[ {l}_{M} ( x , y ) ]}^{{α}_{M}} * {\prod }_{j = 1}^{M} {{[ {c}_{j} ( x , y ) ]}^{{β}_{j}} [ {s}_{j} ( x , y ) ]}^{{ϒ}_{j}} \qquad ( 1 )$$

In Equation (1), the loss values at all the scales are aggregated in a manner of exponential power weighting and multiplication. Herein, x and y separately indicate the two images, l indicates the loss value based on the luminance information, c indicates the loss value based on the contrast map, and s indicates the loss value based on the structure information. A subscript j=1, . . . , M indicates M scales that separately correspond to total M times of downsampling, j=1 indicates a largest scale, and j=M indicates the smallest scale. The superscripts α, β, and γ each indicate an exponential power of a corresponding term.

The MS-SSIM loss function and the SSIM loss function have similar better image evaluation effect. Compared with the L1 loss and the L2 loss, the MS-SSIM loss for optimization can improve subjective experience of human eyes and meet objective evaluation indicators. If the MS-SSIM loss function is used to optimize an image encoding and decoding network, an optimized image encoding and decoding network can achieve a higher MS-SSIM.

Visual geometry group (visual geometry group, VGG) loss: VGG is the name of an organization that designs a CNN network and names it VGG network. An image loss value determined based on a VGG network is referred to as a VGG loss value. A process of determining a VGG loss value is substantially as follows: A feature of an original image before compression and a feature of a decompressed reconstructed image at a scale (for example, a feature map obtained through convolution calculation at a layer) are separately extracted by using a VGG network, and then a distance between the feature of the original image and the feature of the reconstructed image at this scale is calculated to obtain the VGG loss value. This process is considered as a process of determining a VGG loss value according to a VGG loss function. The VGG loss function focuses on improving reconstruction quality of texture.

Learned perceptual image patch similarity (learned perceptual image patch similarity, LPIPS) loss: an enhanced VGG loss. A multi-scale characteristic is introduced into a process of determining an LPIPS loss value. The process of determining an LPIPS loss value is substantially as follows: Features of the two images at a plurality of scales are separately extracted by using a VGG network, then a distance between the features of the two images at each scale is calculated to obtain a plurality of VGG loss values, and then weighted summation is performed on the plurality of VGG loss values to obtain the LPIPS loss value. This process is considered as a process of determining an LPIPS loss value according to an LPIPS loss function. Similar to the VGG loss function, the LPIPS loss function also focuses on improving reconstruction quality of texture.

Generative adversarial network loss: Features of two images are separately extracted by using a discriminator (also referred to as a discriminator) included in a GAN, and a distance between the features of the two images is calculated to obtain a generative adversarial network loss value. This process is considered as a process of determining a GAN loss value according to a GAN loss function. The GAN loss function also focuses on improving reconstruction quality of texture. The GAN loss includes at least one of a standard GAN loss, a relative GAN loss, a relative average GAN loss, a least squares GAN loss, and the like.

Perceptual loss: a perceptual loss in a broad sense and a perceptual loss in a narrow sense. In this embodiment of this application, the perceptual loss in a narrow sense is used as an example for description. The VGG loss and the LPIPS loss may be considered as a perceptual loss in a narrow sense. However, in another embodiment, a loss calculated based on a depth feature extracted from an image may be considered as a perceptual loss in a broad sense. The perceptual loss in a broad sense may include the perceptual loss in a narrow sense, and may further include a loss, for example, the foregoing GAN loss. The perceptual loss function makes the reconstructed image better satisfy subjective experience of human eyes, but may decrease the PSNR and the MS-SSIM.

### Functional Modules

### Variable Bitrate Module

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value). The scaling factor may be preset. Different quality levels or quantization parameters correspond to different target gain values. If the output of the encoding network is scaled to a smaller value, a bitstream size may be decreased. Otherwise, the bitstream size may be increased.

### Color Format Transform

RGB and YUV are common color spaces. Conversion between RGB and YUV may be performed according to an equation specified in standards such as CCIR 601 and BT.709.

### Separate Structure for Luma and Chroma

Some VAE-based codecs use the YUV color space as an input of an encoder and an output of a decoder. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

In the present specification, a ‘parameter’ is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

### Arithmetic Encoding

Entropy coding is typically employed as a lossless coding. Arithmetic coding is a class of entropy coding, which encodes a message as a binary real number within an interval (a range) that represents the message. Herein, the term message refers to a sequence of symbols. Symbols are selected out of a predefined alphabet of symbols. For example, an alphabet may consist of two values 0 and 1. A message using such alphabet is then a sequence of bits. The symbols (0 and 1) may occur in the message with mutually different frequency. In other words, the symbol probability may be non-uniform. In fact, the less uniform the distribution, the higher is the achievable compression by an entropy code in general and arithmetic code in particular. Arithmetic coding makes use of an a priori known probability model specifying the symbol probability for each symbol of the alphabet. An alphabet does not need to be binary. Rather, the alphabet may consist e.g. of M values 0 to M−1. In general, any alphabet with any size may be used. Typically, the alphabet is given by the value range of the coded data.

A variation of the arithmetic coder improved for a practical use is referred to as a range coder, which does not use the interval [0,1), but a finite range of integers, e.g. from 0 to 255. This range is split according to probabilities of the alphabet symbols. The range may be renormalized if the remaining range becomes too small in order to describe all alphabet symbols according to their probabilities.

One of the main types of entropy coders assigns a unique code to each unique symbol that occurs in the input. These entropy encoders compress data by replacing each fixed-length input symbol with the corresponding variable-length output codeword. For the data streams with some specific entropy characteristics a simple static code may be useful. These static codes include universal codes (such as Elias gamma coding or Fibonacci coding) and Golomb codes (such as unary coding or Rice coding). For the general data streams the code can be constructed based on the following rule: the length of each codeword is approximately proportional to the negative logarithm of the probability of occurrence of that codeword. Therefore, the most common symbols use the shortest codes. Based on the constructed code table, coder compress data by replacing each fixed-length input symbol with the corresponding variable-length prefix-free output codeword. An example of such coding is Huffman coding. The main problem of such a coding is that at least one bit is needed for each input symbol even if the probability of it is close to 1. As a speedup of arithmetic coders, asymmetric numeral systems (ANS) family of entropy coding techniques were invented. Such coders provide combination of the compression ratio of arithmetic coding with a processing cost similar to Huffman coding.

An entropy coder encodes symbols of input alphabet A, having size M, to symbols of alphabet B, having size R, by using an amount of output symbols inversely proportional to the probability of the coded symbols. Usually, probability pᵢ of the symbol aᵢ from the alphabet A means probability of appearance of symbol aᵢ in the arbitrary sequence of symbols from the alphabet A. In other words, probability pᵢ means probability of the event that a received symbol y is equal to aᵢ. Unequal probabilities of different symbols from the alphabet give the potential for compression. If all symbols in the alphabet have the same probabilities pi=1/M, where M is the size of the alphabet A than compression is impossible.

General scheme of the entropy coder is depicted on FIG. 7. In most cases, the output alphabet is {0,1}, and size of the output alphabet is usually equal to 2, the symbols of output binary alphabet are called bits and the sequence of the bits corresponding to the sequence of coded symbols from the input alphabet is called bitstream. As can be seen in FIG. 7, the output symbols of the entropy encoder called bitstream, is the input for the entropy decoder. The output for the entropy decoder is in the same alphabet as the input of the entropy encoder. And the output for the entropy decoder can be called decoded symbols. Besides, alphabet means a set of the symbols, alphabet size means the number of symbols in the input alphabet. Here input symbols are denoted as 0, 1, 2, . . . , M−1, so there are M different symbols in total in the input alphabet. It has to be noted that in this application, alphabet size M always means the size of the input alphabet.

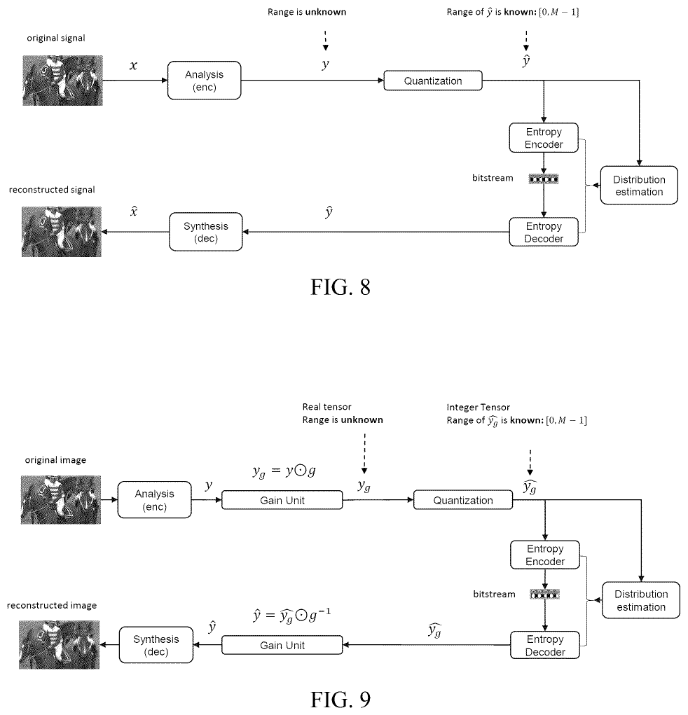

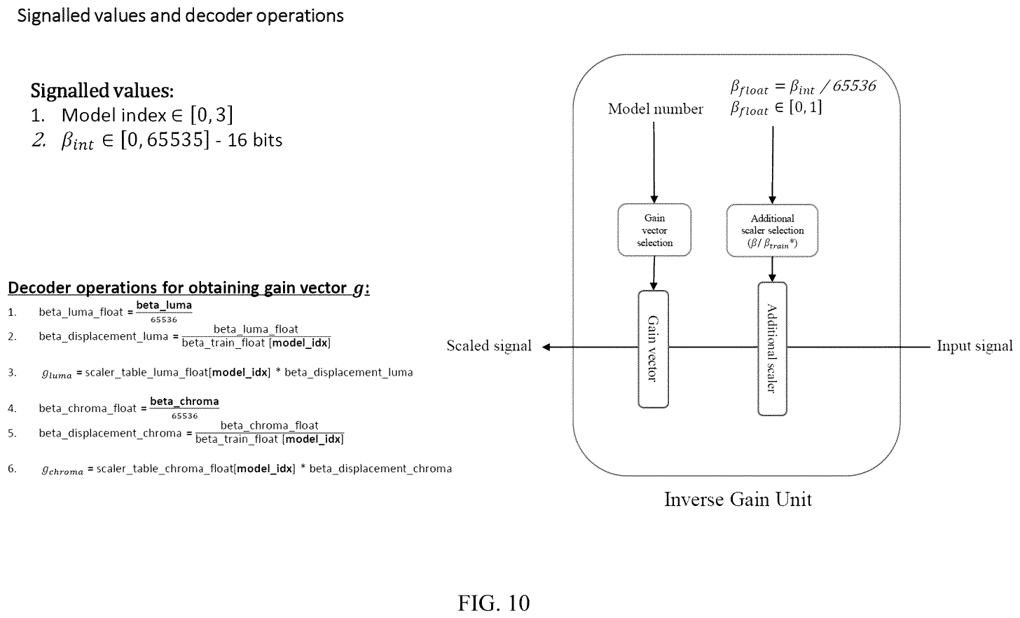

In autoencoder-based coding schemes, entropy coder is used to compress latent space symbols. Distribution estimation can be done in advance (pre-trained histograms) or can be performed using some extra information from the bitstreams and/or information from neighboring latents. A general scheme of usage entropy coding in autoencoder-based coders is depicted on FIG. 8: input signal x is converted to feature (or latent) tensor y, “x” here means input signal corresponding to the image data, “y” here means latent space tensor, the convertion processing here can be called as feature extraction, and the latent space tensor includes latent space elements, the latent space elements will be quantized and put as input to the entropy encoder. In some possible embodiments, the latent space elements will be processed by a gain unit as shown in FIG. 9, then be quantized, and then put as input to the entropy encoder. Tensor y comprise real (not integer) numbers (e.g. floating point values) and range of these numbers is not known in advance. Entropy coder can work only with finite input alphabet, so tensor y is converted to the integer tensor ŷ including values from 0 to M−1, where M is the alphabet size of the entropy coder. Such conversion from continuous set of values to the discrete set is called quantization. The conversion can comprise clamping, rounding and scaling operations. In one exemplary implementation, y can be firstly clamped to range

$$[ - \frac{M}{2} , \frac{M}{2} - 1 ] ,$$

then rounded, then with adding

$$\frac{M}{2}$$

the resulting tensor ŷ is converted to range [0, M−1]. As far as real tensor y is converted to integer tensor ŷ, with all values laying within the range [0,M−1], data of tensor ŷ can be encoded by the entropy coder to the bitstream. On the decoder side the entropy decoder decodes tensor ŷ from the bitstream, which is further transformed to the reconstructed signal \hat{x} with the synthesis part of the autoencoder. It's important to mention, that same parameters of the entropy coder, in particular, a same input alphabet size is used for all possible input signals {x}. So, it could be said that the entropy coding parameters are predefined in conventional method.

As shown in FIG. 9, to control the quantization error (distortion) and the bitstream size (bitrate), a gain unit can be added to the coding scheme. It has to be noted here that, with bigger bitrate, the data can be compressed with better quality, while with lower bitrate, the data can be compressed with lower quality. The process of adjusting compression system parameters to achieve desired ratio between the bitrate and quality (or achieve the desired bitrate) is called rate control. The parameter used during rate control is called rate control parameter β. The rate control parameter β defines quantization step for latent space. A gain unit is used for the rate control. The gain unit is a part on Neural Network which performs multiplying of the latent space tensor y to the gain vector g:y⊙g, where ith channel of the tensor y is multiplied to element g[i] of the vector g. The size of vector g is equal to the number of channels in the latent tensor y, so every channel is multiplied to its own scaling factor g[i]. If a lower bitrate is needed, a smaller gain vector g is selected, and if a higher bitrate is needed, a bigger vector g is used. In this case, before the quantization, the latent tensor y is multiplied with the gain vector g to obtain the real tensor y_{g}. Usually, for a higher bitrate, vector g including greater values is selected, and the range of y_{g} becomes much wider than the range of y, in such case, a predefined alphabet size M, selected once based on the expected y values, becomes not suitable for such y_{g} values. Clipping of y_{g} based on alphabet size M causes significant signal corruption, which cause bad reconstruction quality. In some exemplary implementation the bitrate can be controlled by scalar parameter β, the scalar parameter β can also be called a rate control parameter β, and there is a predefined scheme or pre-trained function g(β) of obtaining the gain vector g for each value β. Usually greater values β result in higher bitrates and for a high bitrate, y_{g} can have a much bigger range than the original values of y. In one possible embodiment, for the systems without gain units, the rate control parameter beta can be specified during the model training as a rate-distortion weighting factor in loss function. E.g. loss function can be as following: loss=β*distortion+number_of_bits, where β means the rate control parameter, number_of_bits is number of spent bits or bits per pixel(bpp). In this case, the model is trained for one specific ratio between the distortion and the bitrate (one rate point).

The signaling of the rate control parameter β in prior art is shown in Table 1, wherein uf(x): The syntax element is coded using a uniform probability distribution. The minimum value of the distribution is 0, while its maximum value is x.

TABLE 1
signaling of the rate control parameter β

| | Descriptor |
|---|---|
| image_header( ){ | |
| ... | |
| model_idx | uf(3) |
| ... | |
| different_betas_for_luma_and_chroma_flag | uf(1) |
| beta_luma | uf(65535) |
| if(different_betas_for_luma_and_chroma_flag) | |
| { | |
| beta_chroma | uf(65535) |
| } | |
| ... | |
| } | |

As shown in FIG. 10, in the conventional methods, model index (model_idx) and βᵢₙₜ are signaled values in the bitstream, in the decoder side, the following operations are performed to calculate a target gain vector g (gₗᵤₘₐ for luma data and g_{chroma} for chroma data):

$$beta\_luma \_float = \frac{beta\_luma}{65536} . \qquad 1$$

$$beta\_displacement \_luma = \frac{beta\_luma \_float}{beta\_train \_float [ model\_idx ]} . \qquad 2$$

$${g}_{luma} = scaler\_table \_luma \_float [ model\_idx ] * beta\_displacement \_luma . \qquad 3$$

$$beta\_chroma \_float = \frac{beta\_chroma}{65536} . \qquad 4$$

$$beta\_displacement \_chroma = \frac{beta\_chroma \_float}{beta\_train \_float [ model\_idx ]} . \qquad 5$$

$${g}_{chroma} = scaler\_table \_chroma \_float [ model\_idx ] * beta\_displacement \_chroma . \qquad 6$$

wherein beta_luma is the rate control parameter for luma data, beta_chroma is the rate control parameter for chroma data, and model_idx is the index of a trained model, scaler_table_luma_float and scaler_table_chroma_float are lookup tables.

As shown in Table 1, the maximum value of beta_luma is 65535, which means that 16 bits are used to signal beta_luma. Similarly, 16 bits are used to signal beta_chroma. That's a lot of bits if 32 bits is used for signaling rate control parameters of each image and increases transmission burden of the bitstream.

Besides, as the decoder obtains a float form beta luma (beta_luma_float) and calculate the gₗᵤₘₐ with the beta_luma_float, the further operations performed on the decoder side is floating-point operation, which take 6 operations and also cannot be reproduced bitexactly between different devices due to Floating Point arithmetic usage.

To solve the abovementioned problem, the embodiment of this application proposes a new signaling scheme of the rate control parameter, particularly, a first coding parameter (beta_displacement_luma or beta_displacement_y) is signaled, wherein the first coding parameter is indicative of a first displacement between a first target rate control parameter and a first reference rate control parameter. By signaling the first coding parameter which indicates the first displacement between the first target rate control parameter and the first reference rate control parameter, the number of bits used for signaling the rate control parameter is reduced, for example, from 16*2-32 to 10*2-20. Besides, the decoder-side algorithm is simplified, the number of operations for obtaining a target gain vector is reduced from 6 to 2 (or 3 to 1 for only luma/chroma data).

So, the number of operations is reduced and also all calculations are made using fixed-point arithmetic which guarantees bit exact behavior on different devices.

The syntax table related to the signaling of the rate control parameter as proposed is shown in Table 2, wherein uf(x): The syntax element is coded using a uniform probability distribution. The minimum value of the distribution is 0, while its maximum value is x.

TABLE 2
signaling of the rate control parameter (newly proposed)

| | Descriptor |
|---|---|
| image_header( ){ | |
| ... | |
| model_idx | uf(3) |
| ... | uf(1) |
| different_betas_for_luma_and_chroma_flag | |
| beta_displacement_luma | uf(1023) |
| if(different_betas_for_luma_and_chroma_flag) | |
| { | |
| beta_displacement_chroma | uf(1023) |
| } | |
| ... | |
| } | |

As shown in Table 2, a first coding parameter (beta_displacement_luma) indicating a first displacement (e.g., ratio or difference) between a first target rate control parameter (e.g., rate control parameter beta selected by encoder for primary/luma component) and a first reference rate control parameter (e.g., rate control parameter beta used in the model training for the primary/luma component) is signaled, wherein the first coding parameter, the first target rate control parameter and the first reference rate control parameter are for coding luma data of the image; a flag (different_betas_for_luma_and_chroma_flag, or different_betas_for_y_and_uv_flag, or independent_beta_uv) indicating whether to use different rate control parameters for coding luma data and chroma data of the image is signaled; (different_betas_for_luma_and_chroma_flag, or when the flag different_betas_for_y_and_uv_flag, or independent_beta_uv) is equal to a first value, for example, one, a second coding parameter (beta_displacement_chroma) which is indicative of a second displacement (e.g., ratio or difference) between a second target rate control parameter (e.g., rate control parameter beta selected by encoder for secondary/chroma component) and a second reference rate control parameter (e.g., rate control parameter beta used in the model training for the secondary/chroma component) is signaled, wherein the second coding parameter, the second target rate control parameter and the second reference rate control parameter are for coding chroma data of the image; further, a third coding parameter (model_idx) which is indicative of an index of a trained model associated with the first reference rate control parameter and/or the second reference rate control parameter is signaled.

In Table 2, the parameters and flags are signaled in an image header (i.e., picture header), in other implementations, the parameters and flags can be signaled in other headers or parameter sets of the bitstream, for example, in a channel header, sequence parameter set, picture parameter set, etc. In an embodiment, the first coding parameter is designated as beta_displacement_luma or beta_displacement_y. In an embodiment, the second coding parameter is designated as beta_displacement_chroma or beta_displacement_uv.

In Table 2, the maximum value of beta_displacement_luma is 1023, and the maximum value of beta_displacement_chroma is 1023 as well, which means only 10 bits are used to signal beta_displacement_luma and 10 bits are used to signal beta_displacement_chroma. In other implementations, N bits is used to signal beta_displacement_luma and M bits is used to signal beta_displacement_chroma, wherein N is equal to M or N is not equal to M, N and M are positive integers. For example, N can be equal to 8, 10, 12, 16, etc. M can be equal to 6, 8, 10, 12, 16, etc. Now binary code is used with uniform distribution, e.g. 1 will be signalled as 00000 00001 and 1023 will be signalled as 11111 11111.

In an embodiment, the first coding parameter and/or the second coding parameter is represented by a fixed-point value. By signaling the first coding parameter and/or the second coding parameter with fixed-point value, fixed point arithmetic is used in both encoder and decoder, so new architecture of the gain unit can be used in codec parts which are sensitive to the arithmetic stability, e.g. entropy part. That is, the stability and versatility of this method is improved.

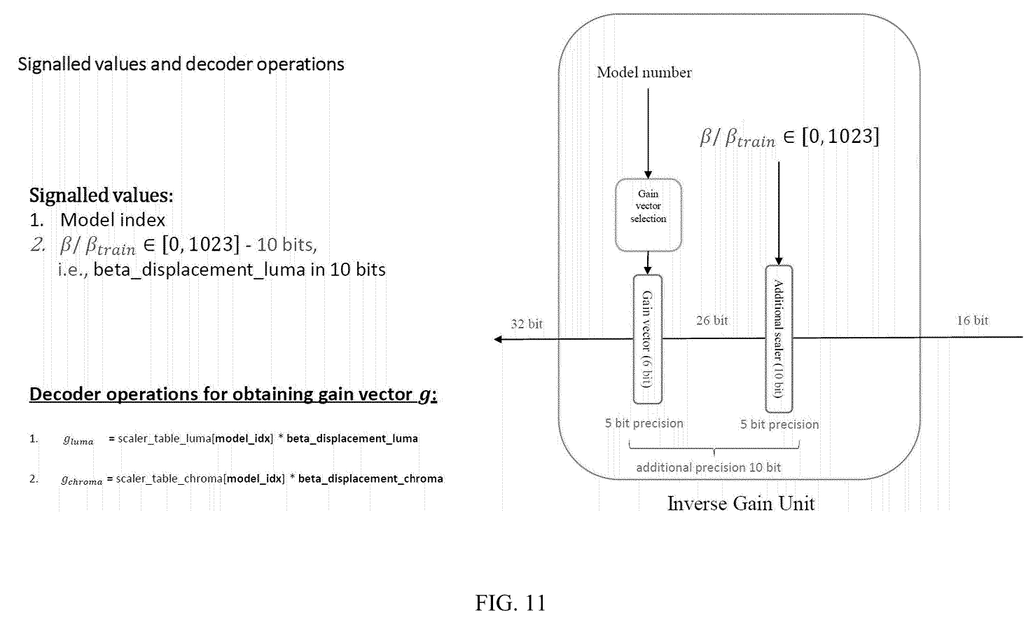

As shown in FIG. 11, in the proposed signaling scheme of the rate control parameter, at least a model index (model_idx) and a first coding parameter (beta_displacement_luma) are signaled values in the bitstream. In the decoder side, the following operations are performed to calculate a target gain vector g (gₗᵤₘₐ for luma data and g_{chroma} for chroma data):

$${g}_{luma} = scaler\_table \_luma [ model\_idx ] * beta\_displacement \_luma . \qquad 1$$

$${g}_{chroma} = scaler\_table \_chroma [ model\_idx ] * beta\_displacement \_chroma . \qquad 2$$

In an embodiment, a flag (different_betas_for_luma_and_chroma_flag) is signaled to indicate whether to use different rate control parameters for coding luma data and chroma data of an image, in this situation, only when the flag indicates that different rate control parameters are used for coding luma data and chroma data of the image, the beta_chroma is signalled.

It is noted that zero value should not be allowed, so we need to subtract 1 before signalling the value to the bitstream: We could or add 1 here as
g=scaler_table[idx_model]*(beta_displacement+1), supposing that beta_displacement is the value which we are going to signall to the bitstream
or
add a text like, before signaling, the offset is subtracted from beta_displacement; the offset can be equal for example to 1 or other values.

Normally we are using one beta for luma and one beta for chroma and they are scalars (not vectors). They can be similar sometimes (see the above syntax table 2).

Values in “scaler_table_luma” are vectors. Number of elements in these vectors is equal to the number of the channels in latent space (y). Currently the size of such vectors for luma is 128, and for chroma is 64.

So, basically, based on the model_idx one vector from the table scaler_table_luma is selected. As far as the number of the elements in this vector is equal to the number of the channels in the latent space, one element (one number) of vector scaler_table_luma[model_idx] is used for scaling one channel in the latent space.

In one embodiment, the first coding parameter is in a logarithmic form (in logarithmic scale) and designated as beta_displacement_log_y or beta_displacement_log_luma or index_displacement_y or index_displacement_luma, wherein the first coding parameter is indicative of a first displacement (eg. ratio or difference) between a first target rate control parameter (e.g., rate control parameter beta selected by encoder for primary component) and a first reference rate control parameter (e.g., rate control parameter beta used in the model training). Whereas in linear scale beta_displacement is the ratio between rate control parameter beta, used for the training the model, and beta, selected by encoder, (β_{displacement}=β/βₜᵣₐᵢₙ), in logarithmic scale beta_displacement_log is the difference between logarithm of rate control parameter beta used for the model training and beta selected by encoder (β_{displacement_log}=logₖ(β)−logₖ(βₜᵣₐᵢₙ)), where k is the predefined constant and can be equal, for example, to the Euler's number e or to 2 or to 10. In one example, β_{displacement_log} can be calculated from β_{displacement} using the additional scaling factor:

$${β}_{displacement \_ log} = \frac{{log}_{k} ( {β}_{displacement} ) \cdot {N}_{σ}}{{log}_{k} ( {σ}_{max} ) - {log}_{k} ( {σ}_{min} )}$$

where k, N_{σ}, σₘₐₓ and σₘᵢₙ are the predefined constant; k can be equal to, for example, the Euler's number e or 2; σₘᵢₙ can be equal to, for example, 0.11 or 0.2; σₘₐₓ can be equal to, for example, 100 or 30; N_{σ} can be equal to 35 or 32. This equation can be used for both the primary/luma component and the secondary/chroma component, maybe with different values for the hyperparameters in the equation.

The main benefit of using the logarithmic scale is complexity reduction caused by changing a multiplication/division operation to an addition/subtraction operation.

The syntax table related to the signaling of the rate control parameter in a logarithmic form as proposed is shown in Table 3, wherein descriptor u(x) means the corresponding syntax element (i.e., the syntax element in the same line with the descriptor) is coded using a uniform probability distribution. The minimum codeword is 0, while the maximum one is 2^{x}−1. x is an integer positive number, it can be equal to, for example, 12 or other integer positive numbers less than 12, or other integer positive numbers larger than 12.

TABLE 3
signaling of the rate control parameter (newly proposed)

| | Descriptor |
|---|---|
| model_header( ) { | |
| independent_beta_uv | u(1) |
| beta_displacement_log_y | u(x) |
| if( independent_beta_uv) | |
| beta_displacement_log_uv | u(x) |
| model_id | u(2) |
| ... | |
| } | |

wherein in Table 3,

independent_beta_uv is a flag (false/true) which indicates whether the rate control parameter (β) for primary and secondary components are the same. In one embodiment, the primary component means luma component, and the secondary component means chroma component.

beta_displacement_log_y is a parameter indicating ratio between rate control parameter beta selected by encoder for primary component and one used in the model training. The parameter beta_displacement_log_y is in a logarithmic form. In one embodiment, the primary component means luma component. In the encoder side, the original beta_displacement_log_y may be in the range of [−2^{N-1}, 2^{N-1}−1], but descriptor u(x) in Table 3 allows only signal positive values, so the actual signaled beta_displacement_log_y in the bitstream may be an adjusted value of the original beta_displacement_log_y (for example, adding 2^{N-1} to the original beta_displacement_log_y before signaling). In the decoder side, after receiving beta_displacement_log_y, which is a positive value, an intermediate parameter betaDisplacementLogY is derived, wherein betaDisplacementLogY=beta_displacement_log_y−2^{N-1}, wherein this N is equal to the x in descriptor u(x) for beta_displacement_log_y, i.e., N is the number of bits used to signal beta_displacement_log_y. betaDisplacementLogY will be used to derive the gain vector. The number of bits used to signal beta_displacement_log_y may be equal to, for example, 12 or other integer positive numbers less than 12, or other integer positive numbers larger than 12.

beta_displacement_log_uv is a parameter indicating ratio between rate control parameter beta selected by encoder for secondary component and one used in the model training. In one embodiment, the secondary component means chroma component. The parameter beta_displacement_log_uv is in a logarithmic form. In the encoder side, the original beta_displacement_log_uv may be in the range of [−2^{M-1}, 2^{M-1}−1], but descriptor u(x) in Table 3 allows only signal positive values, so the actual signaled beta_displacement_log_uv in the bitstream may be an adjusted value of the original beta_displacement_log_uv (for example, adding 2^{M-1} to the original beta_displacement_log_uv before signaling). In the decoder side, after receiving beta_displacement_log_uv, which is a positive value, an intermediate parameter betaDisplacementLogUV is derived, wherein betaDisplacementLogUV=beta_displacement_log_uv−2^{M-1}, wherein this M is equal to the x in descriptor u(x) for beta_displacement_log_uv, i.e., M is the number of bits used to signal beta_displacement_log_uv. betaDisplacementLogUV will be used to derive the gain vector. The number of bits used to signal beta_displacement_log_uv may be equal to, for example, 12 or other integer positive numbers less than 12, or other integer positive numbers larger than 12.

model_id is an identificator of pre-stored checkpoint with model's weights, model_id=0,1,2,3 or 4.

In an embodiment, when the first coding parameter and the second coding parameter are in logarithm scale, the relation between Table 2 and Table 3 is: different_betas_for_luma_and_chroma_flag in Table 2 can be replaced with independent_beta_uv in Table 3; beta_displacement_luma in Table 2 can be replaced with beta_displacement_log_y in Table 3; beta_displacement_chroma in Table 2 can be replaced with beta_displacement_log_uv in Table 3; model_idx in Table 2 can be replaced with model_id in Table 3.

In Table 3, the parameters and flags are signaled in a model header, in other implementations, the parameters and flags can be signaled in other headers or parameter sets of the bitstream, for example, in a channel header, sequence parameter set, picture parameter set, picture header, image header, etc.

### Control Parameters and Gain Vector Derivation

In an embodiment, in total five models are trained for different range of quality. Model is selected base on modelIdx coded at Picture header. Rate control parameter β controls compression ratio and defines operations in Gain Unit, Inverse Gain Unit and Sigma Scale (may be marked as sGain).

The forward gain vector m is used at encoder side in Gain Unit. Forward gain vector in logarithmic scale m_{log} is used in Sigma scale (module used for scaling the standard deviation tensor). The inverse gain vector m⁻¹ is used at decoder side in Inverse Gain Unit. Both forward m and inverse m⁻¹gain vectors have size [C] equal to the number of channels of residual tensor.

Learnable model includes reference forward gain vector in logarithmic scale m_{log}^{t} for five models t=0, . . . ,4. Elements of vector m_{log}^{t} are 12 bit values. In a possible implementation, elements of vector m_{log}^{t} can be other bit values.

The input of gain vector derivation process is
12-bits variable betaDisplacementLog equal to betaDisplacementLogY for primary and to betaDisplacementLogUV for secondary component;
modelIdx which indicates learnable model to be used;
reference forward gain vector m^{t}_{log} for t=modelIdx.

The output of gain vector derivation process is
forward gain vector in logarithmic scale m_{log};
forward gain vector m;
inverse gain vector m⁻¹.

Forward gain vector in logarithmic scale m_{log} is computed as following:

$${m}_{log} = {{m}^{t}}_{log} + betaDisplacement Log$$

Forward and backward gain vectors m and m⁻¹ are computed as following:

$$stepSize = \frac{( {log}_{k} ( {σ}_{max} ) - {log}_{k} ( {σ}_{min} ) )}{{N}_{σ}}$$

$$m = exp ( \frac{{m}_{log} \cdot stepSize}{{2}^{sigmaPrecision}} )$$

$${m}^{- 1} = \frac{1}{m} .$$

where k, N_{σ}, σₘₐₓ, σₘᵢₙ and sigmaPrecision are the predefined constants; k can be equal to, for example, the Euler's number e or 2 or 10; σₘᵢₙ can be equal for example 0.11 or 0.2; σₘₐₓ can be equal for example 100 or 30; N_{σ} can be equal for example 35 or 32; sigma precision is integer positive number and can be equal for example to 7.

In one embodiment, the forward gain vector m can be replaced with the expression g, accordingly, the forward gain vector in logarithmic scale m_{log} can be replaced with the expression g_{log}, the reference forward gain vector m^{t}_{log} for t=modelIdx can be replaced with the expression g^{t}_{log}; the backward gain vector m⁻¹ can be replaced with the expression g⁻¹.

m_{log} is used in Sigma scale (module used for scaling the standard deviation index tensor). The exemplary implementation of the Sigma scale (Sigma index scale, Standard deviation index scale, CDF table index scale) is provided below.

### Sigma Scale

This process is applied both at encoder and decoder sides, and so it is normative.

The input of this process are
forward gain vector in logarithmic scale m_{log};
standard deviation logarithm tensor l_{σ} of size [C, h₄, w₄], which is an output of Hyper Scale Decoder.

The output of this process is
scaled by forward gain vector standard deviation logarithm tensor I′_{σ} of size [C, h₄, w₄], which goes to the adaptive sigma scale.

Sigma scale modifies standard deviation logarithm tensor I_{σ} [C, h₄, w₄] as following:

$${{I}^{′}}_{σ} [ c , i , j ] = {m}_{log} [ c ] + {I}_{σ} [ c , i , j ] ; i = 0 , ... , \\ {h}_{4} - 1 , j = 0 , ... , {w}_{4} - 1 , c = 0 , ... , C - 1.$$

All elements of the tensor in the same channel are scaled by the same multiplier.

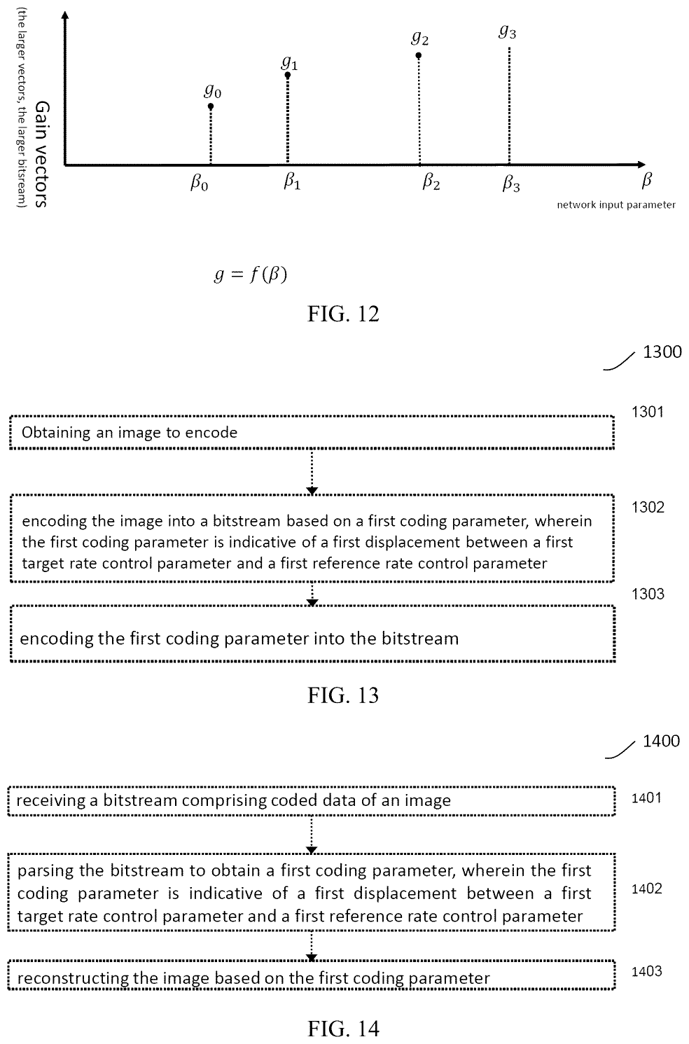

FIG. 12 is a schematic drawing illustrating the relation of the first coding parameter (i.e., network input parameter) β and the gain vectors. During training stage of the neural network (like encoder 101 in FIG. 3A), several values of B are input to the network and trained to get the corresponding gain vectors. In FIG. 12, four pairs of pre-trained [β, gain vector] are shown. It is noted that the present disclosure is not limited to such implementation and in general, other possible number of [β, gain vector] pairs may be pre-trained, for example, 5 pairs, 8 pairs or 10 pairs of [β, gain vector] pairs are pre-trained in possible designs.

The encoding method 1300 shown in FIG. 13 comprises: operation 1301, obtaining an image to encode; operation 1302, encoding the image into a bitstream based on a first coding parameter, wherein the first coding parameter is indicative of a first displacement between a first target rate control parameter and a first reference rate control parameter; operation 1303, encoding the first coding parameter into the bitstream.

According to alternative options, the first coding parameter may be directly encoded into the bitstream and signaled or another coding parameter obtained based on the first coding parameter may be encoded into the bitstream and signaled.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training.

In an embodiment, the first coding parameter is represented by a fixed-point value.

In an embodiment, the first coding parameter is signaled with N bits, wherein N is an integer less than or equal to 16.

In an embodiment, the first coding parameter is represented by a fixed-point value having N bits, wherein K bits of the N bits represent fractional part of the first coding parameter and (N−K) bits of the N bits represent integer part of the first coding parameter, wherein N is an integer, K is an integer less than or equal to N.

In an embodiment, N is equal to 10 and K is equal to 5.

In an embodiment, N is equal to 8 and K is equal to 5.

In an embodiment, N and K can be integers of other values, as long as K is less than or equal to N, which is not limited here.

In an embodiment, the first coding parameter is defined by the following condition:

$${β}_{d} = β / {β}_{r} - x ,$$

wherein β_{d} is the first coding parameter, β is the target rate control parameter, βᵣ is the reference rate control parameter, and x is a predefined number, for example, x can be one or two. In other possible designs, x corresponds to the minimal possible value of

$$\frac{β}{{β}_{r}} ,$$

like

$$\frac{{β}_{min}}{{β}_{r}} .$$

While βr can be βₘᵢₙ or a trained β_{c} which is closest to the target rate control parameter β.

In an embodiment, the first coding parameter is defined by the following condition:

$${β}_{d} = β - {β}_{r} - x ,$$

wherein β_{d} is the first coding parameter, β is the target rate control parameter, βᵣ is the reference rate control parameter, and x is a predefined number. In this design, x is integer, maybe positive integer.

Accordingly, in an embodiment, the encoding the image into a bitstream based on a first coding parameter comprises:
obtaining a target gain vector based on the first coding parameter; and
encoding the image based on the target gain vector;
wherein the target gain vector is defined by the following condition:

$$g = {β}_{d} + x ,$$

wherein g is the target gain vector.

In an embodiment, the first coding parameter is defined by the following condition:

$${β}_{d} = ( β - {β}_{r} - x ) / y ,$$

wherein β_{d} is the first coding parameter, β is the target rate control parameter, βᵣ is the reference rate control parameter, and x and y are predefined numbers. In this design, x and y are integers, maybe positive integers.

In an embodiment, the first coding parameter is defined by the following condition:

$${β}_{d} = ( β / {β}_{r} - x ) / y ,$$

wherein β_{d} is the first coding parameter, β is the target rate control parameter, βᵣ is the reference rate control parameter, and x and y are predefined numbers. In this design, x and y are integers, maybe positive integers.

Accordingly, in an embodiment, the encoding the image into a bitstream based on a first coding parameter comprises:
obtaining a target gain vector based on the first coding parameter; and
encoding the image based on the target gain vector;
wherein the target gain vector is defined by the following condition:

$$g = {β}_{d} \times y + x ,$$

wherein g is the target gain vector.

In an embodiment, wherein the first coding parameter, the first target rate control parameter and the first reference rate control parameter are for coding luma data (a primary or luma) of the image.

In an embodiment, the method further comprises:
encoding a second coding parameter into the bitstream, wherein the second coding parameter is indicative of a second displacement between a second target rate control parameter and a second reference rate control parameter;
wherein the second coding parameter, the second target rate control parameter and the second reference rate control parameter are for coding chroma data (a secondary or chroma component) of the image.

The second displacement may be a difference or a ratio. The second target rate control parameter may be a rate control parameter selected by an encoder performing the method for encoding an image according to the first aspect and any implementation thereof and the second reference rate control parameter may be a rate control parameter used in model training.

In an embodiment, the encoding of second coding parameter is based on a flag indication indicating that different rate control parameters are used for coding luma data and chroma data of the image.

In an embodiment, the second coding parameter is represented by a fixed-point value.

The signaling of the second coding parameter is similar to the signaling of the first coding parameter, maybe with different bits for signaling the first coding parameter and the second coding parameter.

In an embodiment, the method further comprises:
encoding a third coding parameter for deriving a target gain vector into the bitstream.

In an embodiment, the third coding parameter is indicative of an index of a trained model associated with the first reference rate control parameter and/or the second reference rate control parameter.

In an embodiment, the target gain vector is defined by the following condition:

$$g = scaler\_table [ idx\_model ] \times ( {β}_{d} + x )$$

wherein g is the target gain vector, scaler_table is a lookup table, idx_model is the third coding parameter, β_{d} is the first coding parameter, x is a predefined number and (β_{d}+x) is not equal to zero.

In an embodiment, (β_{d}+x) is a positive integer number.

In an embodiment, each element of elements in the lookup table is represented by M bits fixed-point values, wherein P bits of the M bits represent fractional part of one element of the elements.

In an embodiment, M is equal to 6 and P is equal to 5.

In an embodiment, the first coding parameter and/or the second coding parameter is signaled using one or more of the following codes:
binary code;
unary code;
truncated unary code; and
exp-Golomb code.

In an embodiment, the first coding parameter is in logarithmic scale.

In an embodiment, the first coding parameter, the target rate control parameter and the reference rate control parameter are in logarithmic scale.

In an embodiment, the second coding parameter is in logarithmic scale.

In an embodiment, N is equal to 12.

In an embodiment, encoding the first coding parameter into the bitstream comprises: obtaining an adjusted value of the first coding parameter;
encoding the adjusted value of the first coding parameter into the bitstream.

In an embodiment, the adjusted value of the first coding parameter is obtained by adding 2^{N-1} to an original value of the first coding parameter, wherein N is the number of bits used to signal the first coding parameter. The adjusted value may be a value of the above-mentioned other coding parameter.

In an embodiment, the first coding parameter is defined by the following condition:

$${β}_{d} = \frac{{log}_{k} ( β / {β}_{r} ) \cdot {N}_{σ}}{{log}_{k} ( {σ}_{max} ) - {log}_{k} ( {σ}_{min} )}$$

wherein β_{d} is the first coding parameter, β is the target rate control parameter, βᵣ is the reference rate control parameter and k, N_{σ}, σₘₐₓ and σₘᵢₙ are predefined constant.

In an embodiment, k is equal to the Euler's number e or 2, σₘᵢₙ is equal to 0.11 or 0.2, σₘₐₓ is equal to 100 or 30 and N_{σ} is equal to 35 or 32.

In an embodiment, the first coding parameter is defined by the following condition:

$${β}_{d} = {log}_{k} ( β / {β}_{r} )$$

wherein β_{d} is the first coding parameter, β is the target rate control parameter, βᵣ is the reference rate control parameter and k is a predefined constant.

In an embodiment, k is equal to the Euler's number e or 2.

In an embodiment, the encoding the image into a bitstream based on a first coding parameter comprises:
obtaining a target gain vector based on the first coding parameter; and
encoding the image based on the target gain vector;
wherein the target gain vector is defined by the following condition:

$$g = scaler\_idx \_model ] + {β}_{d \_ log}$$

wherein g is the target gain vector, scaler_table is a lookup table, idx_model is indicative of an index of a trained model associated with the first reference rate control parameter and/or the second reference rate control parameter, β_{d_log} is the first coding parameter.

In an embodiment, the encoding the image into a bitstream based on a first coding parameter comprises:
obtaining a target gain vector based on the first coding parameter; and
encoding the image based on the target gain vector;
wherein the target gain vector is defined as follows:

$${m}_{log} = {m}_{log}^{t} + betaDisplacement Log$$

wherein m_{log} is the target gain vector, m^{t}_{log} is a reference forward gain vector for a model with index t, t is indicative of an index of a trained model associated with the first reference rate control parameter and/or the second reference rate control parameter and betaDisplacementLog is associated with the first coding parameter. For example, betaDisplacementLog denotes the first coding parameter or the above-mentioned other coding parameter.

In an embodiment, the first target rate control parameter is a rate control parameter selected by encoder for primary/luma component, the first reference rate control parameter is a rate control parameter used in model training (for the primary/luma component).

In an embodiment, the second target rate control parameter is a rate control parameter selected by encoder for secondary/chroma component, the second reference rate control parameter is a rate control parameter used in model training (for the secondary/chroma component).

### Decoding Methods

FIG. 14 is a flow diagram illustrating an exemplary method for decoding an image based on a neural network architecture, comprising: operation 1401, receiving a bitstream comprising coded data of the image; operation 1402, parsing the bitstream to obtain a first coding parameter, wherein the first coding parameter is indicative of a first displacement between a first target rate control parameter and a first reference rate control parameter; operation 1403, reconstructing the image based on the first coding parameter.

The first displacement may be a difference or a ratio. The first target rate control parameter may be a rate control parameter selected by an encoder performing the method for encoding an image according to the first aspect and any implementation thereof and the first reference rate control parameter may be a rate control parameter used in model training.

According to an option (option A), parsing the bitstream to obtain a first coding parameter comprises parsing another coding parameter (syntax element) from the bitstream and obtaining the first coding parameter based on the other coding parameter.

According to another option (option B), parsing the bitstream to obtain a first coding parameter comprises directly parsing the first coding parameter from the bitstream. According to this option reconstructing the image based on the first coding parameter may comprise obtaining another coding parameter based on the parsed first coding parameter and reconstructing the image based on the other coding parameter.

In an embodiment, the first coding parameter is represented by a fixed-point value.

In an embodiment, the first coding parameter is signaled with N bits, wherein N is an integer less than or equal to 16.

In an embodiment, the first coding parameter is represented by a fixed-point value having N bits, wherein K bits of the N bits represent fractional part of the first coding parameter and (N−K) bits of the N bits represent integer part of the first coding parameter, wherein N is an integer, K is an integer less than or equal to N.

In an embodiment, N is equal to 10 and K is equal to 5.

In an embodiment, N is equal to 8 and K is equal to 5.

In an embodiment, wherein the first coding parameter is defined by the following condition:

$${β}_{d} = β / {β}_{r} - x ,$$

wherein β_{d} is the first coding parameter, β is the target rate control parameter, βᵣ is the reference rate control parameter, and x is a predefined number.

In an embodiment, the first coding parameter is defined by the following condition:

$${β}_{d} = β - {β}_{r} - x ,$$

wherein β_{d} is the first coding parameter, β is the target rate control parameter, βᵣ is the reference rate control parameter, and x is a predefined number.

In an embodiment, the first coding parameter is defined by the following condition:

$${β}_{d} = ( β - {β}_{r} - x ) / y ,$$

wherein β_{d} is the first coding parameter, β is the target rate control parameter, βᵣ is the reference rate control parameter, and x and y are predefined numbers.

In an embodiment, the reconstructing the image based on the first coding parameter comprises:
obtaining a target gain vector based on the first coding parameter; and
reconstructing the image based on the target gain vector;
wherein the target gain vector is defined by the following condition:

$$g = {β}_{d} + x ,$$

wherein g is the target gain vector.

In an embodiment, the reconstructing the image based on the first coding parameter comprises:
obtaining a target gain vector based on the first coding parameter; and
reconstructing the image based on the target gain vector;
wherein the target gain vector is defined by the following condition:

$$g = {β}_{d} \times y + x ,$$

wherein g is the target gain vector.

In an embodiment, the first coding parameter, the first target rate control parameter and the first reference rate control parameter are for coding luma data (a primary or luma component) of the image.

In an embodiment, the method further comprises:
parsing the bitstream to obtain a second coding parameter, wherein the second coding parameter is indicative of a second displacement between a second target rate control parameter and a second reference rate control parameter;
wherein the second coding parameter, the second target rate control parameter and the second reference rate control parameter are for coding chroma data (a secondary or chroma component) of the image.

The second displacement may be a difference or a ratio. The second target rate control parameter may be a rate control parameter selected by an encoder performing the method according to the first aspect and any implementation thereof and the second reference rate control parameter may be a rate control parameter used in model training.

In an embodiment, the parsing of second coding parameter is based on a flag indication indicating that different rate control parameters are used for coding luma data and chroma data of the image.

In an embodiment, the second coding parameter is represented by a fixed-point value.

In an embodiment, the method further comprises:
parsing the bitstream to obtain a third coding parameter for deriving a target gain vector.

In an embodiment, the third coding parameter is indicative of an index of a trained model associated with the first reference rate control parameter and/or the second reference rate control parameter.

In an embodiment, wherein the target gain vector is defined by the following condition:

$$g = scaler\_table [ idx\_model ] \times ( {β}_{d} + x )$$

wherein g is the target gain vector, scaler_table is a lookup table, idx_model is the third coding parameter, β_{d} is the first coding parameter, x is a predefined number and (β_{d}+x) is not equal to zero.

In an embodiment, (β_{d}+x) is a positive integer number.

In an embodiment, each element of elements in the lookup table is represented by M bits fixed-point values, wherein P bits of the M bits represent fractional part of one element of the elements.

In an embodiment, M is equal to 6 and P is equal to 5.

In an embodiment, the first coding parameter and/or the second coding parameter is signaled using one or more of the following codes:
binary code;
unary code;
truncated unary code; and
exp-Golomb code.

In an embodiment, the first coding parameter is in logarithmic scale.

In an embodiment, the first coding parameter, the target rate control parameter and the reference rate control parameter are in logarithmic scale.

In an embodiment, the second coding parameter is in logarithmic scale.

In an embodiment, N is equal to 12.

In an embodiment, reconstructing the image based on the first coding parameter comprises:
obtaining an intermediate parameter (for example, the other coding parameter according to option B mentioned above) by subtracting 2^{N-1} from the first coding parameter, wherein N is the number of bits used to signal the first coding parameter;
reconstructing the image based on the intermediate parameter.

In an embodiment, the reconstructing the image based on the first coding parameter comprises:
obtaining a target gain vector based on the first coding parameter; and
reconstructing the image based on the target gain vector;
wherein the target gain vector is defined by the following condition:

$$g = scaler\_table [ idx\_model ] + {β}_{d \_ log}$$

wherein g is the target gain vector, scaler_table is a lookup table, idx_model is indicative of an index of a trained model associated with the first reference rate control parameter and/or the second reference rate control parameter, β_{d_log} is the first coding parameter.

In an embodiment, the reconstructing the image based on the first coding parameter comprises:
obtaining a target gain vector based on the first coding parameter; and
reconstructing the image based on the target gain vector;
wherein the target gain vector is defined as follows:

$${m}_{log} = {m}_{log}^{t} + betaDisplacement Log$$

wherein m_{log} is the target gain vector, m^{t}_{log} is a reference forward gain vector for a model with index t, t is indicative of an index of a trained model associated with the first reference rate control parameter and/or the second reference rate control parameter and betaDisplacementLog is associated with the first coding parameter. For example, denotes the first coding parameter or the above-mentioned other coding parameter.

In an embodiment, the first target rate control parameter is a rate control parameter selected by encoder for primary/luma component, the first reference rate control parameter is a rate control parameter used in model training (for the primary/luma component).

In an embodiment, the second target rate control parameter is a rate control parameter selected by encoder for secondary/chroma component, the second reference rate control parameter is a rate control parameter used in model training (for the secondary/chroma component).

### Encoding Devices and Decoding Devices

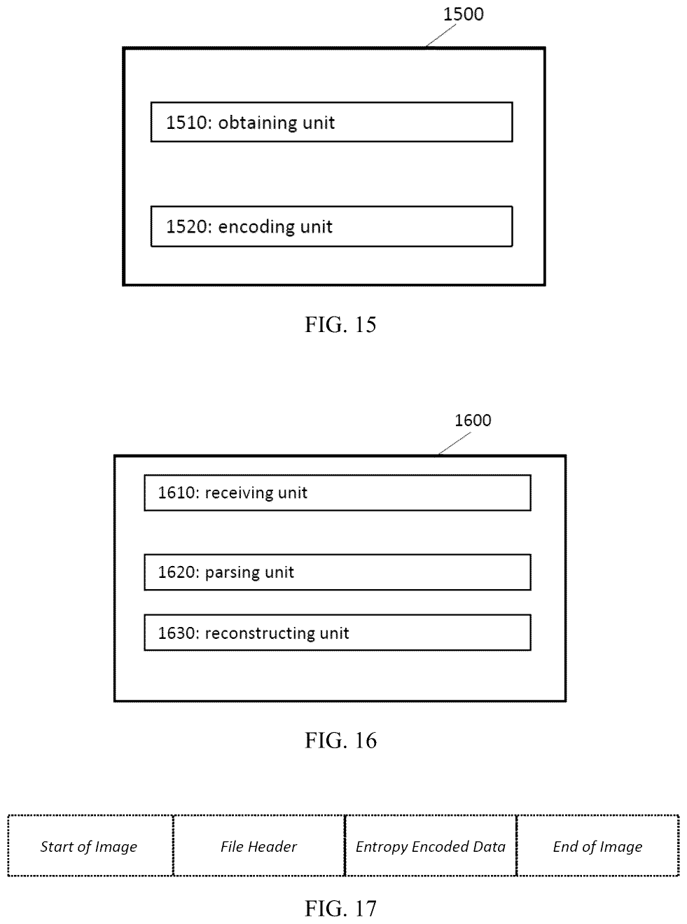

Moreover, as already mentioned, the present disclosure also provides devices which are configured to perform the operations of the methods described above. FIG. 15 shows an encoding device 1500 for encoding an image. The device 1510 comprises: an obtaining unit configured to obtain the image; an encoding unit 1520 configured to encode the image into a bitstream based on a first coding parameter, wherein the first coding parameter is indicative of a first displacement between a first target rate control parameter and a first reference rate control parameter; wherein the encoding unit 1520 is further configured to encode the first coding parameter into the bitstream. The encoding device 1500 may be configured to perform the method for encoding an image as described in the design options above.

Corresponding to the abovementioned encoding device 1500, a decoding device 1600 is shown in FIG. 16 for decoding a bitstream to reconstruct an image. The device may comprise: a receiving unit 1610 configured to receive a bitstream comprising coded data of the image; a parsing unit 1620 configured to parse the bitstream to obtain a first coding parameter, wherein the first coding parameter is indicative of a first displacement between a first target rate control parameter and a first reference rate control parameter; and a reconstructing unit 1630 configured to reconstruct the image based on the first coding parameter. The decoding device 1600 may be configured to perform the method for decoding an image as described in the design options above.

It is noted that these devices may be further configured to perform any of the additional features including exemplary implementations mentioned above. For example, a device is provided for decoding a feature map for processing by a neural network based on a bitstream, the device comprising a processing circuitry configured to perform operations of any of the decoding methods discussed above. Similarly, a device is provided for encoding a feature map for processing by a neural network into a bitstream, the device comprising a processing circuitry configured to perform operations of any of the encoding methods discussed above.

Further devices may be provided, which make use of the devices 1500 and/or 1600. For instance a device for image or video encoding may include the encoding device 1500. In addition, it may include the decoding device 1600. A device for image or video decoding may include the decoding device 1600 and/or the encoding device 1500.

Further, a coding system may be provided, which make use of the devices 1500 and/or 1600. For instance, the coding system may be deployed in a server. The server receives a bitstream, then using the device 1600 or other decoders to decode the bitstream to obtain images, then the images are encoded by using the device 1500 or other encoders. After encoding, the newly obtained bitstream is stored and/or transmitted to other devices.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

In FIG. 17, a bitstream structure is illustrated that might be provided.

It is noted that the bitstream may be obtained by means of a wireless network or wired network. The bitstream may be transmitted from a website, server, or other remote source using a coaxial cable, fiber optic cable, twisted pair, digital subscriber line (DSL), or wireless technologies such as infrared, radio, microwave, WIFI, Bluetooth, LTE or 5G.

The bitstream may be a sequence of bits, in the form of a network abstraction layer (NAL) unit stream or a byte stream, that forms the representation of a sequence of access units (AUs) forming one or more coded video sequences (CVSs).

In a specific example, the bitstream formats specifies the relationship between a network abstraction layer (NAL) unit stream and a byte stream, either of which are referred to as the bitstream.

The bitstream can be in one of two formats: the NAL unit stream format or the byte stream format. The NAL unit stream format is conceptually the more “basic” type. The NAL unit stream format comprises a sequence of syntax structures called NAL units. This sequence is ordered in decoding order. There are constraints imposed on the decoding order (and contents) of the NAL units in the NAL unit stream.

The byte stream format can be constructed from the NAL unit stream format by ordering the NAL units in decoding order and prefixing each NAL unit with a start code prefix and zero or more zero-valued bytes to form a stream of bytes. The NAL unit stream format can be extracted from the byte stream format by searching for the location of the unique start code prefix pattern within this stream of bytes.

The bitstream may comprise coded data of an image and a first coding parameter, wherein the first coding parameter is indicative of a first displacement between a first target rate control parameter and a first reference rate control parameter.

In an embodiment, the first coding parameter is represented by a fixed-point value.

In an embodiment, the first coding parameter is signaled with N bits, wherein N is an integer less than or equal to 16.

In an embodiment, the first coding parameter is represented by a fixed-point value having N bits.

In an embodiment, the first coding parameter, the first target rate control parameter and the first reference rate control parameter are for coding luma data of the image.

In an embodiment, the bitstream further comprises a second coding parameter, wherein the second coding parameter is indicative of a second displacement between a second target rate control parameter and a second reference rate control parameter;
wherein the second coding parameter, the second target rate control parameter and the second reference rate control parameter are for coding chroma data of the image.

In an embodiment, the bitstream further comprises a flag indicating whether to use different rate control parameters for coding luma data and chroma data of the image.

In an embodiment, the second coding parameter is represented by a fixed-point value.

In an embodiment, the bitstream further comprises a third coding parameter, wherein the third coding parameter is indicative of an index of a trained model associated with the first reference rate control parameter and/or the second reference rate control parameter.

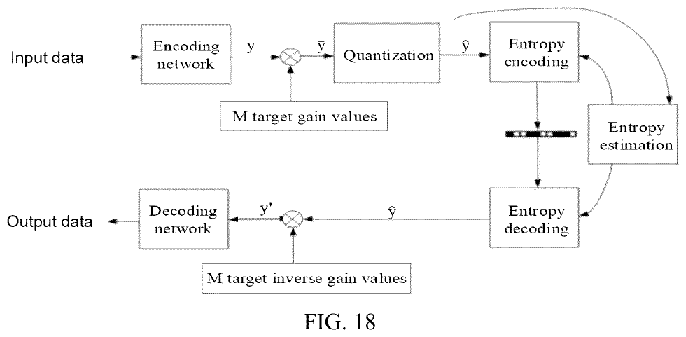

FIG. 18 shows the encoding and decoding process using a gain vector scheme.

### Some Exemplary Implementations in Hardware and Software

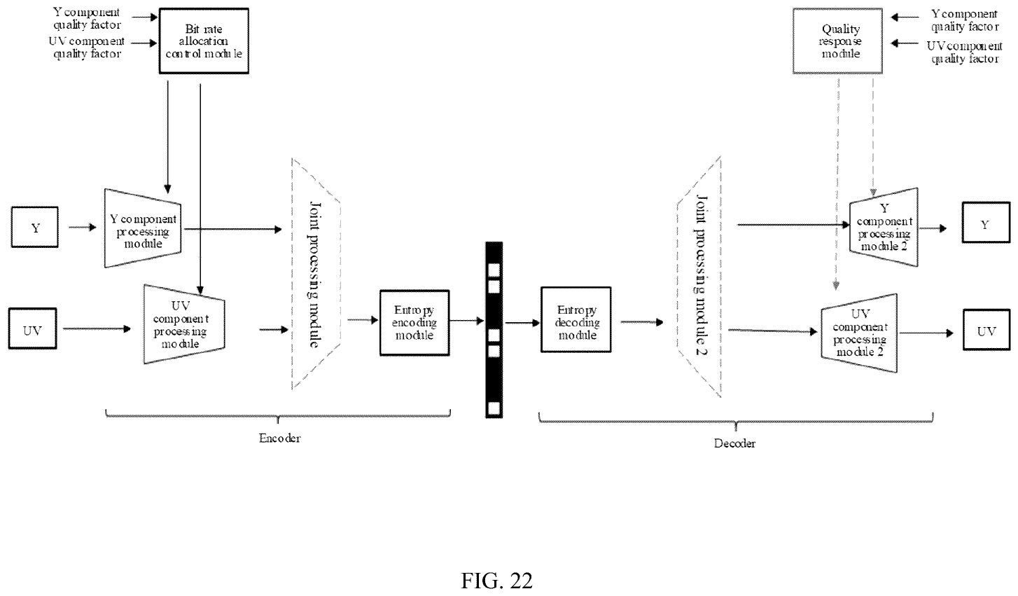

FIG. 22 is a block diagram showing an example of a video coding system configured to implement embodiments of the present disclosure;

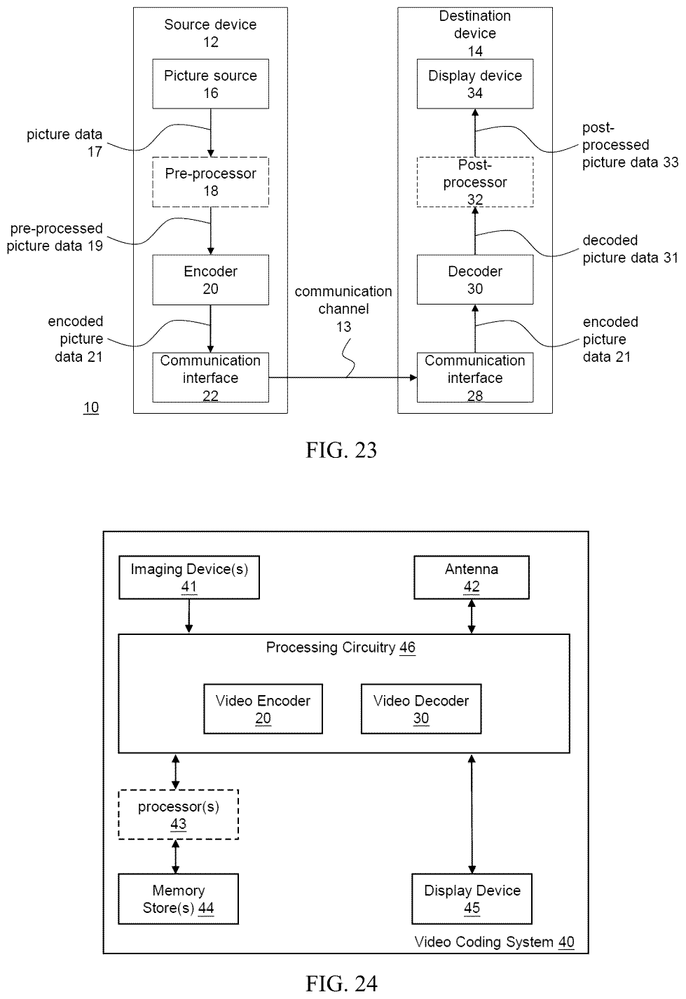

The corresponding system which may deploy the above-mentioned encoder-decoder processing chain is illustrated in FIG. 23. FIG. 23 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 23, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 23 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 23 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 23 may vary depending on the actual device and application.

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 24.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 23 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

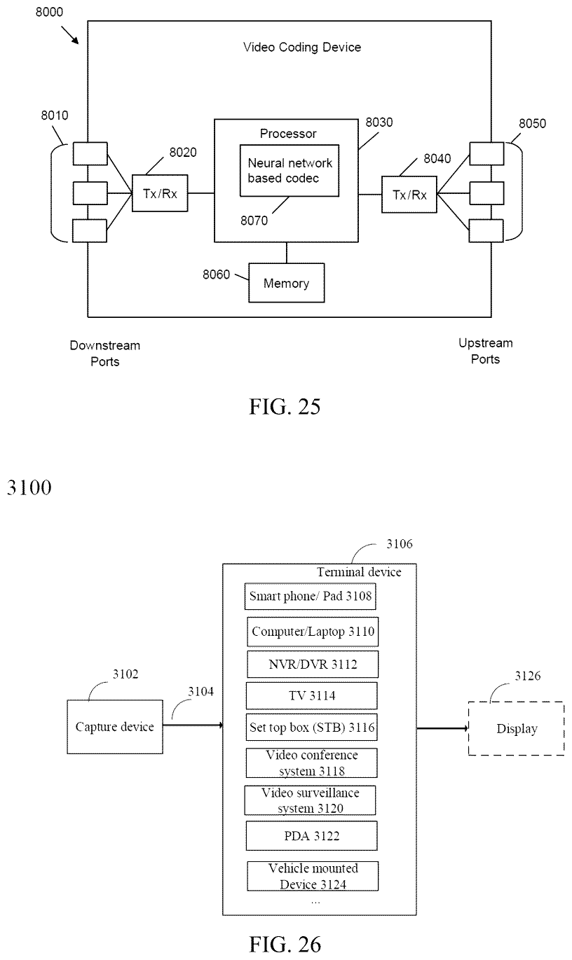

FIG. 25 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 23 or an encoder such as video encoder 20 of FIG. 23.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

FIG. 28 is a simplified block diagram of an apparatus that may be used as either or both of the source device 12 and the destination device 14 from FIG. 23 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an embodiment. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

FIG. 29 is a block diagram of a video coding system 10000 according to an embodiment of the disclosure.

A platform 10002 in the system 10000 can be could sever or local sever. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

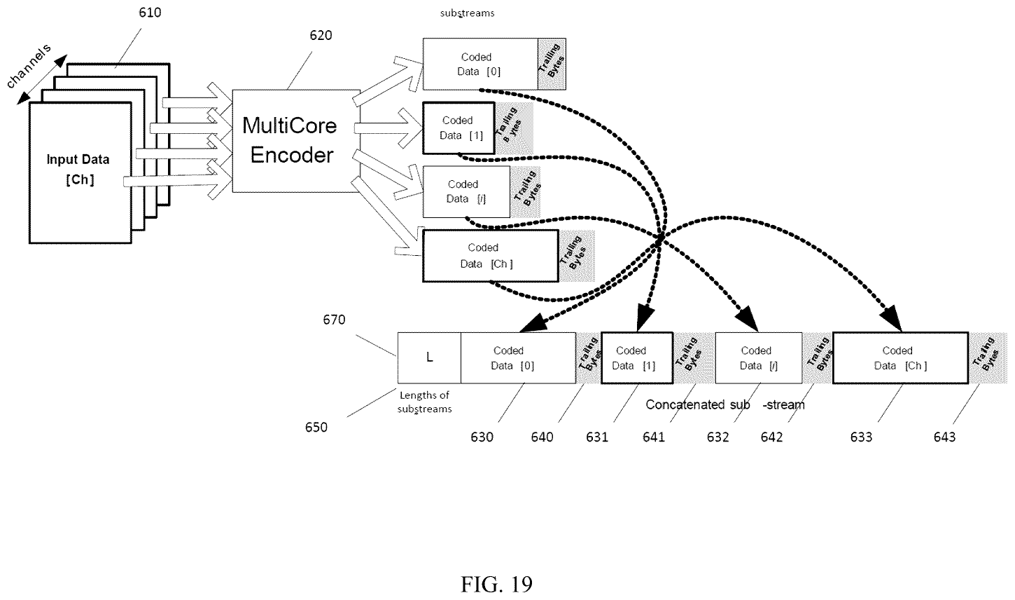

The entropy decoding may be performed in parallel, for example by a multi-core decoder. In addition, only parts of the entropy decoding may be performed in parallel. FIG. 19 shows an exemplary scheme of a parallel (e.g. a multi-core) encoder 620. Each of the input data channels 610 may be encoded into an individual substream including coded bits 630-633 and trailing bits 640-643. The lengths of the substreams 650 are signaled. In parallel processing implementations, the bitstream consists of several substreams, which are concatenated in a final step. Each of the substreams needs to be finalized. This because the substreams are encoded independently of each other, so that the encoding (and thus also decoding) of one substream does not require previous encoding (or decoding) of another one or more substreams.

The input data channels may refer to channels obtained by processing some data by a neural network. For example, the input data may be feature channels such as output channels or latent representation channels of a neural network. In an exemplary implementation, the neural network is a deep neural network and/or a convolutional neural network or the like. The neural network may be trained to process pictures (still or moving). The processing may be for picture encoding and reconstruction or for computer vision such as object recognition, classification, segmentation, or the like. In general, the present disclosure is not limited to any particular kind of tasks or neural networks. Rather, the present disclosure is applicable for encoding any kind of data coming from a plurality of channels, which are to be generally understood as any sources of data. Moreover, the channels may be provided by a pre-processing of source data.

Implementation within Picture Coding

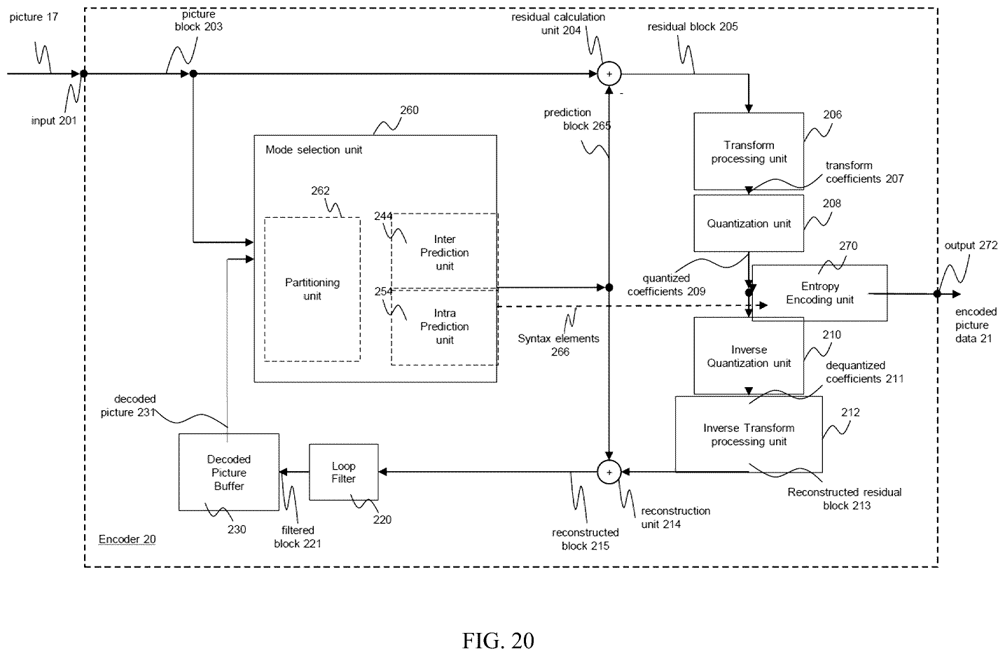

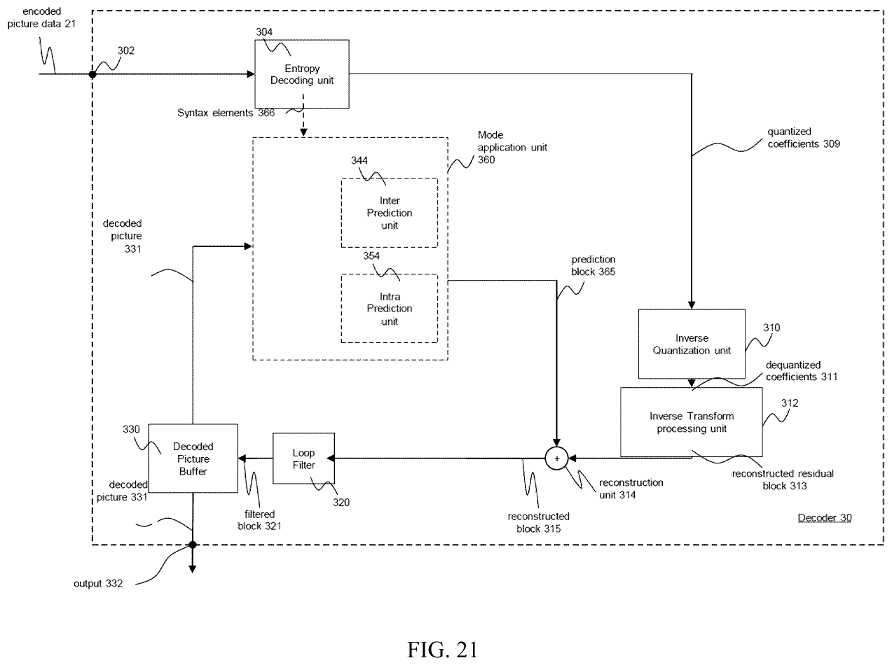

One possible deployment can be seen in FIGS. 20 and 21.

FIG. 20 shows a schematic block diagram of an example encoder 20 that is configured to implement the techniques of the present application. In the example of FIG. 20, the encoder 20 includes an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The entropy coding 270 may implement the arithmetic coding methods or apparatuses as described above.

The mode selection unit 260 may include an inter prediction unit 244, an intra prediction unit 254 and a partitioning unit 262. Inter prediction unit 244 may include a motion estimation unit and a motion compensation unit (not shown). An encoder 20 as shown in FIG. 20 may also be referred to as hybrid encoder or an encoder according to a hybrid video/image codec.

The encoder 20 may be configured to receive, e.g. via input 201, a picture 17 (or picture data 17 or point claud data, motion flow or other type of media data), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also includes the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RGB format or color space a picture includes a corresponding red, green and blue sample array. However, in video coding each pixel is typically represented in a luminance and chrominance format or color space, e.g. YCbCr, which includes a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YcbCr format includes a luminance sample array of luminance sample values (Y), and two chrominance sample arrays of chrominance values (Cb and Cr). Pictures in RGB format may be converted or transformed into YcbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 color format.

Embodiments of the encoder 20 may comprise a picture partitioning unit (not depicted in FIG. 20) configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks. The abbreviation AVC stands for Advanced Video Coding.

In further embodiments, the encoder 20 may be configured to receive directly a block 203 of the picture 17, e.g. one, several or all blocks forming the picture 17. The picture block 203 may also be referred to as current picture block or picture block to be coded.

Like the picture 17, the picture block 203 again is or can be regarded as a two-dimensional array or matrix of samples with intensity values (sample values), although of smaller dimension than the picture 17. In other words, the block 203 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 203 define the size of block 203. Accordingly, a block may, for example, an M×N (M-column by N-row) array of samples, or an M×N array of transform coefficients.

Embodiments of the encoder 20 as shown in FIG. 20 may be configured to encode the picture 17 block by block, e.g. the encoding and prediction is performed per block 203.

Embodiments of the encoder 20 as shown in FIG. 20 may be further configured to partition and/or encode the picture using slices (also referred to as video slices), where a picture may be partitioned into or encoded using one or more slices (typically non-overlapping), and each slice may comprise one or more blocks (e.g. CTUs).

Embodiments of the encoder 20 as shown in FIG. 20 may be further configured to partition and/or encode the picture using tile groups (also referred to as video tile groups) and/or tiles (also referred to as video tiles), where a picture may be partitioned into or encoded using one or more tile groups (typically non-overlapping), and each tile group may comprise, e.g. one or more blocks (e.g. CTUs) or one or more tiles, where each tile, e.g. may be of rectangular shape and may comprise one or more blocks (e.g. CTUs), e.g. complete or fractional blocks.

FIG. 21 shows an example of a decoder 30 that is configured to implement the techniques of this present application. The decoder 30 is configured to receive encoded picture data 21 (e.g. encoded bitstream 21), e.g. encoded by encoder 20, to obtain a decoded picture 331. The encoded picture data or bitstream includes information for decoding the encoded picture data, e.g. data that represents picture blocks of an encoded slice (and/or tile groups or tiles or subpictures) and associated syntax elements.

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 21), e.g. any or all of inter prediction parameters (e.g. reference picture index and motion vector), intra prediction parameter (e.g. intra prediction mode or index), transform parameters, quantization parameters, loop filter parameters, and/or other syntax elements. Entropy decoding unit 304 maybe configured to apply the decoding algorithms or schemes corresponding to the encoding schemes as described with regard to the entropy encoding unit 270 of the encoder 20. Entropy decoding unit 304 may be further configured to provide inter prediction parameters, intra prediction parameter and/or other syntax elements to the mode application unit 360 and other parameters to other units of the decoder 30. Decoder 30 may receive the syntax elements at the video slice level and/or the video block level. In addition or as an alternative to slices and respective syntax elements, tile groups and/or tiles and respective syntax elements may be received and/or used. The entropy decoding may implement any of the above mentioned arithmetic decoding methods or apparatuses.

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

Embodiments of the decoder 30 as shown in FIG. 21 may be configured to partition and/or decode the picture using slices (also referred to as video slices), where a picture may be partitioned into or decoded using one or more slices (typically non-overlapping), and each slice may comprise one or more blocks (e.g. CTUs).

Embodiments of the decoder 30 as shown in FIG. 21 may be configured to partition and/or decode the picture using tile groups (also referred to as video tile groups) and/or tiles (also referred to as video tiles), where a picture may be partitioned into or decoded using one or more tile groups (typically non-overlapping), and each tile group may comprise, e.g. one or more blocks (e.g. CTUs) or one or more tiles, where each tile, e.g. may be of rectangular shape and may comprise one or more blocks (e.g. CTUs), e.g. complete or fractional blocks.

Other variations of the decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the decoder 30 can have the inverse-quantization unit 310 and the inverse-transform processing unit 312 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

FIG. 26 is a block diagram showing a content supply system 3100 for realizing content distribution service. This content supply system 3100 includes capture device 3102, terminal device 3106, and optionally includes display 3126. The capture device 3102 communicates with the terminal device 3106 over communication link 3104. The communication link may include the communication channel 13 described above. The communication link 3104 includes but not limited to WIFI, Ethernet, Cable, wireless (3G/4G/5G), USB, or any kind of combination thereof, or the like.

The capture device 3102 generates data, and may encode the data by the encoding method as shown in the above embodiments. Alternatively, the capture device 3102 may distribute the data to a streaming server (not shown in the Figures), and the server encodes the data and transmits the encoded data to the terminal device 3106. The capture device 3102 includes but not limited to camera, smart phone or Pad, computer or laptop, video conference system, PDA, vehicle mounted device, or a combination of any of them, or the like. For example, the capture device 3102 may include the source device 12 as described above. When the data includes video, the video encoder 20 included in the capture device 3102 may actually perform video encoding processing. When the data includes audio (i.e., voice), an audio encoder included in the capture device 3102 may actually perform audio encoding processing. For some practical scenarios, the capture device 3102 distributes the encoded video and audio data by multiplexing them together. For other practical scenarios, for example in the video conference system, the encoded audio data and the encoded video data are not multiplexed. Capture device 3102 distributes the encoded audio data and the encoded video data to the terminal device 3106 separately.

In the content supply system 3100, the terminal device 310 receives and reproduces the encoded data. The terminal device 3106 could be a device with data receiving and recovering capability, such as smart phone or Pad 3108, computer or laptop 3110, network video recorder (NVR)/digital video recorder (DVR) 3112, TV 3114, set top box (STB) 3116, video conference system 3118, video surveillance system 3120, personal digital assistant (PDA) 3122, vehicle mounted device 3124, or a combination of any of them, or the like capable of decoding the above-mentioned encoded data. For example, the terminal device 3106 may include the destination device 14 as described above. When the encoded data includes video, the video decoder 30 included in the terminal device is prioritized to perform video decoding. When the encoded data includes audio, an audio decoder included in the terminal device is prioritized to perform audio decoding processing.

For a terminal device with its display, for example, smart phone or Pad 3108, computer or laptop 3110, network video recorder (NVR)/digital video recorder (DVR) 3112, TV 3114, personal digital assistant (PDA) 3122, or vehicle mounted device 3124, the terminal device can feed the decoded data to its display. For a terminal device equipped with no display, for example, STB 3116, video conference system 3118, or video surveillance system 3120, an external display 3126 is contacted therein to receive and show the decoded data.

When each device in this system performs encoding or decoding, the picture encoding device or the picture decoding device, as shown in the above-mentioned embodiments, can be used.

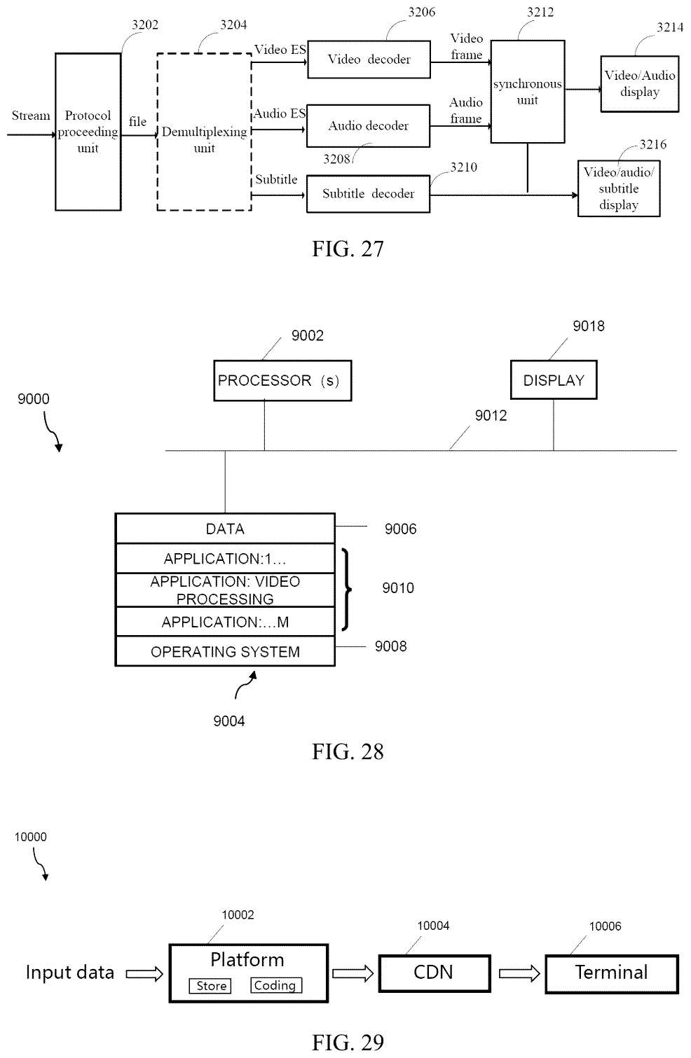

FIG. 27 is a diagram showing a structure of an example of the terminal device 3106. After the terminal device 3106 receives stream from the capture device 3102, the protocol proceeding unit 3202 analyzes the transmission protocol of the stream. The protocol includes but not limited to Real Time Streaming Protocol (RTSP), Hyper Text Transfer Protocol (HTTP), HTTP Live streaming protocol (HLS), MPEG-DASH, Real-time Transport protocol (RTP), Real Time Messaging Protocol (RTMP), or any kind of combination thereof, or the like.

After the protocol proceeding unit 3202 processes the stream, stream file is generated. The file is outputted to a demultiplexing unit 3204. The demultiplexing unit 3204 can separate the multiplexed data into the encoded audio data and the encoded video data. As described above, for some practical scenarios, for example in the video conference system, the encoded audio data and the encoded video data are not multiplexed. In this situation, the encoded data is transmitted to video decoder 3206 and audio decoder 3208 without through the demultiplexing unit 3204.

Via the demultiplexing processing, video elementary stream (ES), audio ES, and optionally subtitle are generated. The video decoder 3206, which includes the video decoder 30 as explained in the above mentioned embodiments, decodes the video ES by the decoding method as shown in the above-mentioned embodiments to generate video frame, and feeds this data to the synchronous unit 3212. The audio decoder 3208, decodes the audio ES to generate audio frame, and feeds this data to the synchronous unit 3212. Alternatively, the video frame may store in a buffer (not shown in FIG. 27) before feeding it to the synchronous unit 3212. Similarly, the audio frame may store in a buffer (not shown in FIG. 27) before feeding it to the synchronous unit 3212.

The synchronous unit 3212 synchronizes the video frame and the audio frame, and supplies the video/audio to a video/audio display 3214. For example, the synchronous unit 3212 synchronizes the presentation of the video and audio information. Information may code in the syntax using time stamps concerning the presentation of coded audio and visual data and time stamps concerning the delivery of the data stream itself.

If subtitle is included in the stream, the subtitle decoder 3210 decodes the subtitle, and synchronizes it with the video frame and the audio frame, and supplies the video/audio/subtitle to a video/audio/subtitle display 3216.

A coder comprising processing circuitry for carrying out the method according to any one of the proposed methods is provided.

A storage medium, wherein the storage medium stores a bitstream obtained by using any one of the proposed methods is provided.

A bitstream comprising coded data of an image and a first coding parameter is provided, wherein the first coding parameter is indicative of a first displacement between a first target rate control parameter and a first reference rate control parameter.

In an embodiment, wherein the first coding parameter is represented by a fixed-point value.

In an embodiment, wherein the first coding parameter is signaled with N bits, wherein N is an integer less than or equal to 16.

In an embodiment, wherein the first coding parameter is represented by a fixed-point value having N bits.

In an embodiment, wherein the first coding parameter, the first target rate control parameter and the first reference rate control parameter are for coding luma data of the image.

In an embodiment, wherein the bitstream further comprises a second coding parameter, wherein the second coding parameter is indicative of a second displacement between a second target rate control parameter and a second reference rate control parameter;
wherein the second coding parameter, the second target rate control parameter and the second reference rate control parameter are for coding chroma data of the image.

In an embodiment, wherein the bitstream further comprises a flag indicating whether to use different rate control parameters for coding luma data and chroma data of the image.

In an embodiment, wherein the second coding parameter is represented by a fixed-point value.

In an embodiment, wherein the bitstream further comprises a third coding parameter, wherein the third coding parameter is indicative of an index of a trained model associated with the first reference rate control parameter and/or the second reference rate control parameter.

It is noted that all remaining aspects of the encoding method or decoding method are also relevant to the bitstream structure.

A system for delivering a bitstream is provided, comprising:
at least one storage medium, configured to store at least one bitstream as mentioned above;
a video streaming device, configured to obtain a bitstream from one of the at least one storage medium, and send the bitstream to a terminal device; wherein the video streaming device comprises a content server or a content delivery server.

In an embodiment, wherein the system further comprises:
one or more processor, configured to perform encryption processing on the at least one bitstream to obtain at least one encrypted bitstream;
the at least one storage medium, configured to store the encrypted bitstream;
or,
the one or more processor, configured to converting a bitstream of the at least one bitstream in a first format into a bitstream in a second format;
the at least one storage medium, configured to store the bitstream in the second format.

In an embodiment, wherein the system further comprises:
a receiver, configured to receive a first operation request; and;
the one or more processor, configured to determine a target bitstream in the at least one storage medium in response to the first operation request;
a transmitter, configured to send the target bitstream to a terminal-side apparatus.

In an embodiment, wherein the one or more processor is further configured to:
encapsulate a bitstream to obtain a transport stream in a third format; and
the transmitter, is further configured to:
send the transport stream in the third format to the terminal-side apparatus for display; or,
send the transport stream in the third format to storage space for storage.

The present disclosure is not limited to the above-mentioned system, and either the picture encoding device or the picture decoding device in the above-mentioned embodiments can be incorporated into other system, for example, a car system.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, a cloud server, an application server, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A method for encoding an image, comprising:
obtaining the image;
encoding the image into a bitstream based on a first coding parameter, wherein the first coding parameter is indicative of a first displacement between a first target rate control parameter and a first reference rate control parameter; and
encoding the first coding parameter into the bitstream.

2. The method of claim 1, wherein the first coding parameter is represented by a fixed-point value.

3. The method of claim 1, wherein the first coding parameter is signaled with N bits, wherein N is an integer less than or equal to 16.

4. The method of claim 3, wherein Nis equal to 12.

5. The method of claim 1, wherein the first displacement is one of a ratio and a difference.

6. The method of claim 1, wherein the first coding parameter, the first target rate control parameter and the first reference rate control parameter are for coding luma data of the image.

7. The method of claim 1, wherein the first coding parameter is signaled using one or more of the following codes:
binary code;
unary code;
truncated unary code; and
exp-Golomb code.

8. The method of claim 1, wherein at least one of the first coding parameter, the first target rate control parameter and the first reference rate control parameter is in logarithmic scale.

9. The method of claim 1, wherein the first target rate control parameter is a rate control parameter selected by an encoder and the first reference rate control parameter is a rate control parameter used in model training.

10. A method for decoding an image, comprising:
receiving a bitstream comprising coded data of the image;
parsing the bitstream to obtain a first coding parameter, wherein the first coding parameter is indicative of a first displacement between a first target rate control parameter and a first reference rate control parameter; and
reconstructing the image based on the first coding parameter.

11. The method of claim 10, wherein the first coding parameter is represented by a fixed-point value.

12. The method of claim 10, wherein the first coding parameter, the first target rate control parameter and the first reference rate control parameter are for coding luma data of the image.

13. The method of claim 10, wherein the first coding parameter is signaled using one or more of the following codes:
binary code;
unary code;
truncated unary code; and
exp-Golomb code.

14. The method of claim 10, wherein at least one of the first coding parameter, the first target rate control parameter and the first reference rate control parameter is in logarithmic scale.

15. A decoding device for decoding an image, comprising:
one or more processors; and
a computer-readable storage medium coupled to the one or more processors and storing instructions, wherein when the instructions are executed by the one or more processors, the device is enabled to perform the following operations:
receiving a bitstream comprising coded data of the image;
parsing the bitstream to obtain a first coding parameter, wherein the first coding parameter is indicative of a first displacement between a first target rate control parameter and a first reference rate control parameter; and
reconstructing the image based on the first coding parameter.

16. The device of claim 15, wherein the first coding parameter is represented by a fixed-point value.

17. The device of claim 15, wherein the first coding parameter, the first target rate control parameter and the first reference rate control parameter are for coding luma data of the image.

18. The device of claim 15, wherein the first coding parameter is signaled using one or more of the following codes:
binary code;
unary code;
truncated unary code; and
exp-Golomb code.

19. The device of claim 15, wherein at least one of the first coding parameter, the first target rate control parameter and the first reference rate control parameter is in logarithmic scale.

20. The device of claim 15, wherein the first target rate control parameter is a rate control parameter selected by an encoder and the first reference rate control parameter is a rate control parameter used in model training.
